(19) United States
(12) Patent Application Publication
(10) Pub. No.: US 2007/0068816 A1
(43) Pub. Date: Mar. 29, 2007

(54) Hydrogel preparation and process of manufacture thereof

(75) Inventors: David Henry Solomon, Murrumbeena (AU); Greg Guanghua Qiao, Doncaster East (AU); Alan Yik Lum Kwok, Hawthorn (AU)

Correspondence Address: MORGAN LEWIS & BOCKIUS LLP, 1111 PENNSYLVANIA AVENUE NW, WASHINGTON, DC, 20004, US

(73) Assignee: L

(21) Appl. No.: 11/171,542

(22) Filed: Jul. 1, 2005

Related U.S. Application Data
(63) Continuation-in-part of application No. PCT/AU03/01680, filed on Dec. 17, 2003.

(30) Foreign Application Priority Data
Dec. 18, 2002 (AU) 2002-953408
Dec. 18, 2002 (AU) 2002-953409
May 14, 2003 (AU) 2003-902305

(51) Int. Cl. G01N 27/00

(52) U.S. Cl. 204/606

(57) ABSTRACT

A separation medium comprising a hydrogel preparation having macropores and micropores, wherein the hydrogel preparation is prepared by reacting a first gel component and a second gel component in an aqueous solvent. The first gel component comprises a first monomer, oligomer, polymer, or combination thereof having at least one polymerizable double bond, and a first crosslinker having at least two polymerizable double bonds. The second gel component comprises a second monomer, oligomer, polymer, or combination thereof having at least one pendant functional group per repeat unit, and a second crosslinker having at least two functional groups, each capable of reacting with the at least one pendant functional group of the second monomer, oligomer, polymer, or combination thereof.

### CROSS-REFERENCE TO RELATED APPLICATIONS

This application is a continuation-in part of the co-pending U.S. National Stage of International Application No. PCT/AU03/001680, internationally filed on Dec. 17, 2003, published as WO 2004/055057 A1 on Jul. 1, 2004, and which claims priority to Australian Patent Application Nos. 2002-953408, 2002-953409, and 2003-902305, filed Dec. 18, 2002, Dec. 18, 2002, and May 14, 2003, respectively. The contents of each of these is hereby incorporated by reference in its entirety.

### TECHNICAL FIELD

The present invention relates to a separation medium comprising a hydrogel preparation consisting of macropores and micropores obtainable by using a hydro-organic solvent.

### BACKGROUND ART

Hydrogels for separation processes—In many applications of separation processes, it is desirable to have a porous matrix with good water compatibility and mechanical properties. In general, two broad classes of matrixes have been used. One general class is derived from polymers by precipitation procedures such as Diffusion Induced Phase Separation (DIPS) and Thermally Induced Phase Separation (TIPS). These matrixes are relatively hydrophobic. A typical example is polysulfones membranes, which sometime require surface treatment or modification by physical adsorption of hydrophilic polymers (e.g. poly(vinyl alcohol)) to achieve satisfactory water wetting properties.

In many applications it is preferred to synthesize hydrogels from water-soluble monomers by incorporating crosslinking monomers into the polymer network. Typical examples are the range of hydrogels prepared by the free-radical co-polymerization of acrylamide and N,N-methylenebisacrylamide. Such hydrogels are relative to DIPS and TIPS more hydrophilic and more stable since the hydrophilic groups are an integral part of the polymer structure. It is well accepted that the range of monomers suitable for the production of such hydrogels is rather limited, and is restricted to the requirement that both the monomer and the corresponding polymer need to be soluble in the polymerization solvent.

To address this limitation, several attempts have been made to prepare hydrogels by the bulk polymerization of monomers that produce water insoluble polymers. It is well accepted that the porosity of such gels is dependent upon total monomer concentration of the reaction mixture. For example, hydrogels with higher total monomer content will have a tighter network structure because of increased inter-penetration of polymer chains during network formation (Baker, J.; Hong, L.; Blanch, H.; Prausnitz, J. Macromolecules 1994, 27, 1446). As a result of this, and their high polymer content, hydrogels prepared in bulk are normally poor in mechanical strength (glassy and brittle), low in biocompatibility and water content, and possess a very limited pore size range. The absence of water in the synthesis environment of such hydrogels also makes subsequent solvent exchange with water difficult.

Polymerization-induced phase separation (PIPS) is a process in which an initially homogeneous solution of monomer and solvent becomes phase separated during the course of its polymerization. In hydrogel synthesis, PIPS can be induced by a number of factors: continuous increase in the fraction of molecules with high molecular weight, the unfavorable interactions between the polymer and other species in the reaction mixture, or the elasticity of the resultant polymeric network (Dudek, K J. J. Polym. Sci. Polym. Symp. 1967, 16, 1289; Boots, H. M. J.; Kloosterboer, J. G.; Serbutoviez, C.; Touwslager, F. J. Macromolecules 1996, 29, 7683). Depending on the relative rates of the phase separation and the polymerization processes, PIPS can occur by the mechanism of nucleation-growth in the metastable region, or by spinodal decomposition in the multiphase coexisting region of the phase diagram (Eligabe, G. E.; Larrondo, H. A.; Williams, R. J. J. Macromolecules 1997, 30, 6550; Eligabe, G. E.; Larrondo, H. A.; Williams, R. J. J. Macromolecules 1998, 31, 8173).

In the homo-polymerizations of a mono-vinyl monomer, during the course of the reaction, because of the continuous increase in the fraction of polymer in the reaction mixture, PIPS can occur if the polymers formed in the reaction mixture are not miscible with the polymerization solvent. For example, PIPS occurs at −30% monomer conversion during the polymerization of a mixture composed of 30% 2-hydroxyethyl methacrylate and 70% water when the molecular weight of the resultant polymer is −300,000; and at −25% monomer conversion during the polymerization of a mixture composed of 20% acrylamide, 32.5% poly(ethylene glycol)-400 when the molecular weight of the resultant polymer is 10,000.

Miscibility In a multi-component system is governed by its Gibbs free energy of mixing (ΔGₘᵢₓ), which is a function of the enthalpies of mixing and the entropies of mixing between the various components in the mixture (ΔGₘᵢₓ=ΔHₘᵢₓ−TΔSₘᵢₓ). Because the enthalpy of mixing between two chemically different polymers is mostly positive, increases in the average molecular weight of the polymer solution will decrease the overall entropy of the system. It is also expected to decrease the miscibility of the polymerization mixture. This leads to the occurrence of PIPS at lower monomer conversions. For example, the onset of PIPS is at 1% monomer conversion during the polymerization of a mixture composed of 20% acrylamide, 32.5% poly(ethylene glycol)-400 when the molecular weight of the resultant polymer is 5,500,000. Polymer systems with higher average molecular weight will be less miscible than corresponding systems with lower average molecular weight.

In a simplified gel formation process by the free radical co-polymerization of mono-vinyl monomer and multi-vinyl crosslinker, linear polymers are first formed in the solution during the fast propagation step, and later crosslinked with other molecules in close proximity by reaction through their pendent double bonds and additional monomer units (Stepto, R. F. T. “Non-linear polymerization, gelation and network formation, structure and properties”, in Stepto, R. F. T. (ed.) Polymer Networks 1998; London, Biackie Academic & Professional, 14-63). Therefore, in a gel formation process, the average molecular weight of the polymer solution increases with increasing monomer conversion because of the ongoing crosslinking reactions.

Because hydrogels are defined as a network with infinite molecular weight which reaches the macroscopic dimensions of the sample itself (Flory P. J. Principles of polymer science. New York: Cornell University Press, 1953 (Chapter IX)), polymers with very high molecular weight are produced in the reaction mixture prior to the formation of a gel network. Such polymers are therefore expected to undergo phase separations when the polymerization solvent is immiscible with their corresponding linear polymer analogues with high molecular weight.

Acrylamide hydrogels, for separation in zone electrophoresis, were introduced in 1959 (Raymond, Weintraub, Science 1959, 130, 711) and widely used as matrices for gels, and other electrophoretic operations. For example, one membrane-based electrophoresis technique (Gradiflow™ (Life Therapeutics, Australia)) involves a fixed boundary preparative electrophoresis method (U.S. Pat. No. 5,650,055, U.S. Pat. No. 5,039,386 and WO 0013776) and utilizes a thin acrylamide hydrogel membrane with a defined pore size (D. B. Rylatt, M. Napoli, D. Ogle, A. Gilbert, S. Lim, and C. H. Nair, J. Chromatog., A, 1999, 865, 145-153). However, despite its widespread popularity, there are several potential hazards and limitations which accompany the use of acrylamide hydrogel. For example, although the polymer is not toxic, exposure to the monomer and crosslinker at manufacture during preparation of the gel poses significant health concerns. In addition, residual and derivative chemical present in the gel may also pose potential health concern.

Currently, the pore size range of commercially available membranes is somewhat limited. For example, large pores suitable for DNA and RNA separations are not routinely available. It is well known that for an acrylamide hydrogel, although an increase in pore size can be achieved by decreasing the polymer content, the mechanical strength and integrity will also be decreased. The loss of gel rigidity places a practical limit on the accessible size separation range of a given material. In order to attempt to overcome these problems and to obtain matrices of higher porosity, Righetti (U.S. Pat. No. 5,785,832) and Uriel (U.S. Pat. No. 3,578,604) proposed polyacrylamide-agarose mixed-bed matrices. The matrix was obtained by a simultaneous but independent process of agarose and acrylamide gelification leading to an intertwining of the two polymers. The agarose used, however, is normally based on naturally occurring raw materials which often have associated chemical and structural impurities.

Righetti (U.S. Pat. No. 5,470,916) described a process for synthesizing polyacrylamide matrixes with large pores. The process consists of adding, to the polymerization monomer mixture, hydrophilic polymers (e.g. polyethylene glycol, polyvinylpyrrolidone, hydroxymethyl cellulose) which, when added at a given concentration to the monomer mixture, force the chains to agglomerate together, thus forming a gel network having fibers of a much larger diameter than a regular, acrylamide hydrogel. It was understood that the large pores were formed due to the competition between gelation and phase separation in the system (Asnaghi, D., Giglio, M., Bossi, A., Righetti, P. G., J. Mol. Strut. 1996, 38, 37). It is, however, hard to control the ranges of pore size obtainable using this technique.

Another approach to the synthesis of hydrogels with large pores is provided by template strategies (Beginn, U., Adv. Mater. 1998, 19, 16). This process resembles macroscopic metal casting processes in which templates preform the shapes of the pores like casting-cores are introduced into a liquid system and subsequently embedded by hardening of the solvent (i.e. polymerization). After removal of these cores from the surrounding matrix the shape of the voids that remain reflects the form of the templates.

Rill et al. (Rill, R. L., Locke, B. R., Liu, Y., Dharia, J., Van Winkle, D. L., Electrophoresis 1996, 17, 1304; Rill, R. L., Van Winkle, D. L., Locke, B. R., Anal. Chem. 1998, 70, 2433, Chakrapani, M., Van Winkle, D. H., Rill, R. L., Langmuir 2002, 18, 6449) reported templated acrylamide hydrogels as gel electrophoresis matrix and potential support for gel permeation chromatography. They showed that templating gels with sodium dodecyl sulfate (SIDS) at concentrations up to 20% altered the electrophoretic separations of SIDS-protein complexes in a manner consistent with the creation of pores by SDS micelles. Anderson (U.S. Pat. No. 5,244,799) described a process in which templated hydrogels were created by polymerizing a mixture of a hydrophilic monomer, polymerizing agent, an ionic surfactant and water. However, the usage of surfactants as template also have a few limitations, such as i) foaming problems during the degassing and the polymerization process; ii) the need to equilibrate the monomer solution (Method from Anderson involve the equilibration of the monomer solution for at least a week); iii) in such procedures, it is difficult to completely remove the ionic surfactant from the hydrogel after the polymerization step. Anderson described an additional step in which the hydrogel was to be treated with a non-ionic surfactant solution while Rill et al. reported the removal of 98% of SDS from the gel upon successive soaking in water.

Residue ionic groups on the hydrogel matrix often caused undesirable electroendosmotic properties when exposed to an electric field, and more importantly, were able to affect biomolecule separation by physical interactions with charged groups on them; and iv) high surfactant concentrations are required to form the necessary interconnecting. templating pores. At such concentrations, polyacrylamide is often incompatible with the ionic surfactant, resulting in undesirable phase separation during the polymerization. For example, Antonietti et al. (Antonietti, M., Caruso, R. A., Goltner, C. G., Weissenberger, M. C. Macromolecules 1999, 32 1383) reported during the formation of a variety of polymer gels such as polyacrylamide in the presence of lyotropic surfactant mesophases that “prior to polymerization all mixtures are transparent, and become opaque or turbid white shortly after the start of the reaction”. Rill also reported that gels formed in the presence of 30% or more SDS became uniformly white as the surfactants were removed.

Undesirable swelling or shrinking has always been a drawback In the use of acrylamide hydrogels in non-aqueous operating systems such as the separation of Ions In non-aqueous systems and the electrophoretic separation of hydrophobic proteins using organic solvents. Hydrogels synthesised in a solvent similar to that of its final operating environment will be more tolerant to solvent compositional changes. Typical solvents used in non-aqueous operating systems include alcohols, glycols, dimethyl formamide (DMF), dimethyl sulfoxide (DMSO), tetramethylurea, formamide, tetramethylene sulfone, chloral hydrate N-methyl acetamide, N-methyl pyrollidone and phenol. It is, however, well known that when amounts of water miscible solvents such as DMF, DMSO, TMU, ethylene glycol, or propylene glycol are added to the acrylamide polymerization mixture, the mechanical strength and clearness of the polymer gel are severely compromised.

Amphiphilic polymer networks of α,ω-(meth)acryloyloxy monomers such as poly(2-hydroxyethyl methacrylate) (poly(HEMA) have been studied extensively as materials for pharmaceutical and biomedical applications, including carriers for controlled drug delivery and materials for prosthetic devices. The mechanical strength provided by the hydrophobic backbone and the hydrophilicity of the hydroxy and ester groups on the polymer side chains make polymers produced from HEMA excellent candidates for hydrogels for separation processes. Zewert and Harrington (U.S. Pat. No. 5,290,411; U.S. Pat. No. 5,290,411; Zewert, T., Harrington, M., Electrophoresis 1992, 13, 817-824; Zewert, T., Harrington, M., Electrophoresis 1992, 13, 824), and Solomon et al. (PCT/AU01/01632) have described the usage of hydrogels prepared from α,ω-(meth)acryloyloxy monomers in various electrophoretic operations.

Most existing 2-Hydroxyethyl methacrylate (HEMA) systems are prepared in bulk, or with <50% diluent. Owing to the hydrophobicity of the network, organic diluents such as ethylene glycol and di(ethylene glycol) are normally used (WO 00/44356; Caliceti, P., Veronese, F., Schiavon, O., II Farmaco 1992, 47, 275, Carenza, M., Radiat. Phys. Chem. 1993, 42, 897). Although the properties of these hydrogels can be modified by crosslinking or by the use of different diluents, their swelling in water is thermodynamically limited to −40% (Havsky, M., Prins, W., Macromolecules 1970, 3, 415; Nakamura, K., Nakagawa, T., Journal of Polymer Science 1975, 13, 2299).

As a result, such HEMA hydrogels are normally poor in mechanical strength (glassy and brittle), low in biocompatibility, low in water content, and possess a very limited pore size range. The absence of water in the synthesis environment of such hydrogels also made subsequent solvent exchange with water difficult. In addition, the toxicity of some of the diluents is of great concern. Such hydrogels have been predominantly used in applications that desire low water swelling, such as contact lenses and transport membranes for gases and ions (Corkhill, P. H., Jolly, A. M., Ng, C. O., Tighe, B. J. Polymer 1987, 28, 1758; Hamilton, C. J., Murphy, S. M., Atherton, N. D., Tighe, B. J., Polymer 1988, 29, 1879).

It is well accepted that the porosity of such hydrogels is dependent upon the particular monomer, particular crosslinking agent, and the degree of crosslinking. For example, hydrogels with higher total monomer content will have a tighter network structure because of increased interpenetration of polymer chains during network formation (Baker. J.; Hong, L.; Blanch, H.; Prausnitz, J. Macromolecules 1994, 27, 1446). It is thus highly desirable to be able to produce an HEMA hydrogel with high water content at a low initial concentration of monomers (<50 wt %) in order to obtain the desired biocompatibility and pore sizes for applications such as electrophoresis separation membranes.

Several attempts have been made to improve the water swelling properties of HEMA hydrogels and to prepare such gel at a low initial concentration of monomers.

i) HEMA hydrogels were synthesised in various hydro-organic solvents. Refojo (Refojo, M., Journal of Polymer Science: Part A-1 (1967), 5, 3103) reported that visually clear hydrogels of poly(2-hydroxyethyl methacrylate) may be prepared by conducting the polymerization in ethylene glycol-water solution. The phase separation limit for this type of system was reported to be 45% of water in the reaction solution, allowing the total monomer concentrations to be decreased by the replacement of monomers with diluent (Warren, T., Prins, W., Macromolecules (1972), 5, 506). In addition to the fact that HEMA hydrogels prepared in such diluent were reported to exhibit a narrow range of swelling at equilibrium in water (41% water) regardless of the initial dilution of the monomer solution and relatively low level of crosslinking. Results from our laboratory have shown that this separation limit is highly dependent upon both the amount of crosslinker and the choices of diluent in the reaction solution, with some formulations forming heterogeneous opaque polymer mass even when the water content is below 45%. Zewert and Harrington (Zewert, T., Harrington, M., Electrophoresis 1992, 13, 817) reported HEMA hydrogel synthesis in aqueous sulfolane solution and concluded that HEMA polymerization is thoroughly incompatible with sulfolane even if sulfolane concentrations are as low as 10%.

ii) Various HEMA derivatives such as the poly(alkylene glycol) esters of acrylic or methacrylic acid (e.g. poly(ethylene glycol) methacrylate) were used instead of HEMA to prepare hydrogels with improved water swelling properties. The disadvantages of such monomers is that they are expensive and difficult to prepare. In addition, the pore size of hydrogels prepared by these monomers is also limited because of their large molecular weight, restricting the number of monomer units available in the monomer mixture.

iii) In order to obtain HEMA hydrogels with improved water swelling properties, it is common to copolymerize HEMA with a hydrophilic monomer such as acrylamide. Bajpai and Shrivastava (Bajpai, A. K., Shrivastava, M. J. Biomater. Sci. Polymer Edn 2002, 13, 237) copolymerised HEMA with acrylamide (% acrylamide >40 mol %) in the presence of a hydrophilic polymer, poly(ethylene glycol) (PEG, MW 600). It was found that the swelling ratio of such hydrogel increases with increasing PEG 600 content in the monomer mixture to a maximum at 4.31% (by weight). Such hydrogels, according to the authors, “could be regarded as a network of polyethylene glycol) and poly(HEMA-co-acrylamide) chains thus creating free volumes of varying meshes for accommodating penetration of water molecules”. It was also stated by Bajpai and Shrivastava that there is no clear advantage of using a highly hydrophilic polymer content—“beyond 0.56 of PEG (600) content (4.31%), the network density of the gel may became so high that mesh sizes of free volumes available between the network chains get reduced . . . thus decreasing the swelling of the gel.” It is clear that the co-polymerization of acrylamide with HEMA does not eliminate the disadvantages associated with acrylamide hydrogels.

The present inventors have now developed new hydrogels suitable for a number of separation techniques. The present invention also provides visually clear hydrogels with good water compatibility and swelling properties to be synthesized from monomers in hydra-organic or organic solvents.

### DISCLOSURE OF INVENTION

In one aspect, the present invention provides a process for producing a polymeric hydrogel having a network containing macropores and micropores, the process comprising: (a) forming a mixture by adding at least one monomer having at least one double bond, at least one crosslinker having at least two double bonds, an initiation system, and an organic additive to form a hydro-organic system with water; and (b) allowing the monomer and crosslinker to copolymerize to form a hydrogel having a polymeric network containing macropores and micropores.

The monomer having at least one double bond may be selected from polyol esters of acrylic or methacrylic acid, where the polyol is selected from a group which includes polyethylene glycol, a range of polyethylene glycol esters or ethers, polypropylene glycol, a range of polypropylene glycol esters or ethers, random or block copolymers of ethylene glycol and propylene glycol, or any suitable polyols such as glycerol, pentaerythritol, ethylene glycol or propylene glycol which are fully or partly esterified. Mixtures consist of at least two of the above monomers can also be used.

Mixtures of the above monomer with any other well-known monomers suitable for free radical polymerization may be used.

In some embodiments of the present invention the monomer is used from about 1 to 80%, in others, from about 5 to 50%.

In some embodiments of the invention the monomer is one or more hydrophilic monomers from the esters of acrylic or methacrylic acids.

In one form, the monomer is hydroxyethyl methacrylate (HEMA).

The crosslinker having at least two double bonds may be selected from esters of acrylic and/or methacrylic acid, or acrylic or methacrylic acid with various polyols. Typical polyols include polyethylene glycol, a range of polyethylene glycol, a range of polypropylene glycol, random or block copolymers of ethylene glycol and propylene glycol, or any suitable polyols such as glycerol, pentaerythritol, ethylene glycol or propylene glycol which may be partly esterified (for example, glycerol can be esterified with two molecules of methacrylic acid to give the crosslinking mixture). Mixtures consist of at least two of the above crosslinkers can also be used.

Mixtures of above crosslinker with any other well-known crosslinkers suitable for free radical polymerization may be used.

In some embodiments of the invention use of the above crosslinker with greater than about 50% in the mixture of crosslinkers; in other embodiments greater than about 80%.

In one form, the crosslinker is ethylene glycol dimethacrylate (EGDMA).

In some embodiments of the invention the polymeric hydrogel is made from a mixture of monomer content of about 10 to 40% M and crosslinker of about 1 to 30% X before polymerization. When HEMA and EGDMA are used, the compositions of monomer mixture of HEMA with EGDMA are less than about 40% M and less than about 20% X, respectively. It will be appreciated, however, that other concentrations can be used depending on the monomer and crosslinker used.

Any suitable free radical producing method can be used as the initiation system. The initiation system can be formed by the redox, thermal or photo initiator(s). In some embodiments the redox initiator is formed by ammonium persulfate (APS) with N,N,N,N′-tetramethylethylenediamine (TEMED).

The organic additive, which may be monomeric or polymeric (such as ethylene glycol or polyethylene glycol), can be a hydrophilic polymer miscible with water and miscible with a linear polymer produced from the monomer used for copolymerization; or a hydrophilic polymer miscible with water and has a similar solubility parameter (±10 MPa^{0.5}) to that of a polymer produced from the monomer used for copolymerization. The organic additive can be a single entity acting as both a porogen to form macropores during the polymerization and a solvent with water to form the hydro-organic solvent.

The organic additive can be selected from ethylene glycol or polyethylene glycol, propylene glycol or polypropylene glycol, random or block copolymers of any of the above mixtures, or any of the above additives that have an ester or ether end group. Mixtures consisting of at least two of the additives can also be used.

In some embodiments of the invention the organic additive has the following 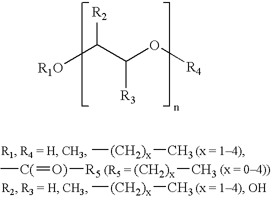
general formulation:

In one form, the organic additive is a polyethylene glycol or polypropylene glycol. The polyethylene glycol can have a molecular weight range from about 100 to 100000; or in some embodiments from about 200 to 10000; or in other embodiments from about 400 to 4000.

The polypropylene glycol typically has a molecular weight range from about 100 to 100000; or in some embodiments from 200 to 10000; or in other embodiments from about 58 to 600.

In some embodiments of the invention the organic additive is a copolymer with a hydrophilic component and a hydrophobic component. In some embodiments the organic additive is a copolymer of polyethylene glycol with polypropylene glycol.

In use, the polymeric hydrogel formed can be used in the hydro-organic solvent or the hydro-organic solvent components exchanged with water.

In another aspect, the present invention provides a polymeric hydrogel having a network containing macropores and micropores produced by the process according to one aspect of the present invention.

In still another aspect, the present invention provides a polymeric hydrogel comprising a network of macropores and micropores formed by copolymerizing at least one monomer having at least one double bond and at least one crosslinker having at least two double bonds in the presence of a organic additive forming a hydro-organic system with water.

The monomer having at least one double bond may be selected from polyol esters of acrylic or methacrylic acid, where the polyol is selected from a group which includes polyethylene glycol, a range of polyethylene glycol esters or ethers, polypropylene glycol, a range of polypropylene glycol esters or ethers, random or block copolymers of ethylene glycol and propylene glycol, or any suitable polyols such as glycerol, pentaerythritol, ethylene glycol or propylene glycol which are fully or partly esterified. Mixtures consist of at least two of the above monomers can also be used.

Mixtures of the above monomer with any other well-known monomers suitable for free radical polymerization may be used.

In some embodiments of the invention use of above monomer with greater than 50% in the mixture of monomers; while in other embodiments it is greater than 80%.

In some embodiments of the invention the monomer is one or more hydrophilic monomers from the esters of acrylic or methacrylic acids.

In one form, the monomer is hydroxyethyl methacrylate (HEMA).

The crosslinker having at least two double bonds may be selected from esters of acrylic and/or methacrylic acid, or acrylic or methacrylic acid with various polyol. Typical polyols are polyethylene glycol, a range of polyethylene glycol, a range of polypropylene glycol, random or block copolymers of ethylene glycol and propylene glycol, or any suitable polyols—such as glycerol, pentaerythritol, ethylene glycol or propylene glycol which may be partly esterified (for example, glycerol can be esterified with two molecules of methacrylic acid to give the crosslinking mixture). Mixtures that consist of at least two of the above crosslinkers can also be used.

Mixtures of above crosslinker with any other well-known crosslinkers suitable for free radical polymerization may be used.

In some embodiments of the invention, use of the above crosslinker with greater than 50% in the mixture of crosslinkers; in others it is greater than 80%.

In one form, the crosslinker is ethylene glycol dimethacrylate (EGDMA).

In some embodiments of the invention the polymeric hydrogel is made from a mixture of monomer content of about 10 to 40% M and crosslinker of about 1 to 30% X before polymerization. When HEMA and EGDMA are used, the compositions of monomer mixture of HEMA with EGDMA are less than about 40% M and less than about 20% X. It will be appreciated, however, that other concentrations can be used depending on the monomer and crosslinker used.

Any suitable free radical producing method can be used as the initiation system. The initiation system is formed by the redox, thermal, or photo initiator(s). In one embodiment the redox initiator is formed by ammonium persulfate (APS) with N,N,N′,N′-tetramethylethylenediamine (TEMED).

The organic additive, which may be monomeric or polymeric, is a hydrophilic polymer miscible with water and miscible with a linear polymer produced from the monomer used for copolymerization; or a hydrophilic polymer miscible with water and has a similar solubility parameter (±10 MPa^{0.5}) to that of a polymer produced from the monomer used for copolymerization. The organic additive can be a single entity acting as both a porogen to form macropores during the polymerization and a solvent with water to form the hydro-organic solvent.

The organic additive can be selected from ethylene glycol or polyethylene glycol, propylene glycol or polypropylene glycol, random or block copolymers of any of the above mixtures, or any of the above additives that have an ester or ether end group. Mixtures consist of at least two of the additives can also be used.

In some embodiments of the invention the organic additive has the following general formulation:

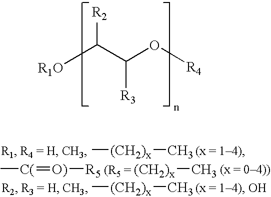

In one form, the organic additive is a polyethylene glycol or polypropylene glycol. In some embodiments of the invention the polyethylene glycol has a molecular weight range from about 100 to 100000; in other embodiments from about 200 to 10000; and in other embodiments from about 400 to 4000.

In some embodiments of the invention the polypropylene glycol typically has a molecular weight range from about 100 to 100000; in others from 200 to 10000; and in others from about 58 to 600.

In some embodiments of the invention the organic additive is a copolymer with a hydrophilic component and a hydrophobic component. In some embodiments the organic additive is a copolymer of polyethylene glycol with polypropylene glycol.

In some embodiments of the invention the mixture is degassed to remove any dissolved oxygen prior to polymerization.

In use, the polymeric hydrogel formed can be used in the hydro-organic solvent or the hydro-organic solvent components exchanged with water.

In another aspect, the present invention provides a separation medium formed from the polymeric hydrogel according to some aspects of the present invention.

In some embodiments of the invention the separation medium is in the form of membrane, slab, beads or column. The medium is suitable as an electrophoretic medium capable of separating large biomolecules or compounds having a molecular weight of at least 2000 k.

In another aspect, the present invention provides a substantially visually clear polymeric hydrogel according to some aspects of the present invention.

The present inventors have found inter alia that by the use of mixtures of water and water-miscible entities as the polymerization solvent, visually clear hydrogels can be prepared even when the polymerization solvent is immiscible with the corresponding linear polymer analogues. For example, a mixture of 20% poly(acrylamide)-5,500,000, 1% poly(vinyl alcohol)-18,000 (88% hydrolyzed), and 79% water is immiscible, but the polymerization of 20% solutions of acrylamide and N,N′-methylenebisacrylamide can give visually clear gels; a mixture of 15% poly(2-hydroxyethyl methacrylate)-300,000, 75% ethylene glycol dimethyl ether or 75% poly(ethylene glycol) dimethyl ether, and 10% water is immiscible, but the polymerization of 15% solutions of 2-hydroxyethyl methacrylate and ethylene glycol dimethacrylate in these solvents can give visually clear gels.

These results are new and unexpected because the general teaching from most scientific literature on monomer selection for hydrogel synthesis is that the polymerization solvent should be a solvent for the linear analogues of the resultant polymeric network.

By the selection of the water-miscible entities, the ‘freezing point’ of the reaction mixture can be controlled such that it occurs at a monomer conversion lower than the critical monomer conversion for the onset of PIPS. The ‘freezing point’ of the reaction mixture is defined as the critical monomer conversion at which the viscosity of the mixture reaches a specific level when the mobility of polymer chains in the mixture becomes negligible and the dynamic concentration fluctuations of pre-gel polymer solutions are frozen in the final network structure. The resultant hydrogels of these systems will be visually clear and have a relatively uniform network because the polymer mixture was frozen in its miscible state before phase separation could occur. Hydrogels prepared by this approach have superior swelling, optical, and mechanical properties to that prepared by systems that reaches the phase boundary before the gel point. Those gels are formed from dispersions of precipitated polymers in the liquid phase (Okay O. Polymer 1999, 40, 4117) and are highly opaque polymer masses that have very different properties from hydrogels synthesized using our approach.

In another aspect, the present invention provides a method for separating one or more compounds according to size using electrophoresis, the method comprising:

(a) providing a medium in the form of polymeric hydrogel having a network containing macropores and micropores according to some aspects of the present invention;

(b) adding one or more compounds to part of the medium; and

(c) applying an electric potential causing at least one compound to pass through the medium, wherein movement through the medium is related to the size of the compound.

In another aspect, the present invention provides a size exclusion electrophoresis system comprising:

(a) a cathode;

(b) an anode; and

(c) a separation medium in the form of polymeric hydrogel having a network containing macropores and micropores according to some aspects of the present invention capable of separating a mixture of compounds according to size, the medium disposed between the anode and cathode.

In some embodiments of the invention the system further includes means for supplying a sample containing one or more compounds to be separated to the system.

In some embodiments of the invention the system further includes means for retaining or capturing a compound separated by the system.

In some embodiments of the invention the system further includes a voltage supply and means for applying an electric potential between the cathode and anode.

The system can be formed by having the separation medium disposed between two ion-permeable barriers forming two chambers either side of the size exclusion medium. Sample containing the compound(s) to be separated can be placed in one of the chambers and, under the influence of the applied voltage, a compound will move through the separation medium in accordance with its size (large molecules elute out first) to the second chamber where it can be retained or collected. It is also possible to have a plurality of different separation media disposed between the cathode and anode. In this form, each separation medium would have a different pore structure so as to be able to separate compounds of different size.

In still another aspect, the present invention provides use of a separation medium in the form of polymeric hydrogel having a network containing macropores and micropores according to some aspects of the present invention in size exclusion electrophoresis.

In yet another aspect, the present invention provides a water-swellable, crosslinked gel, exhibiting an array of pore sizes of micropores and macropores, and comprising: (a) a first gel component comprising a first monomer, oligomer, polymer, or combination thereof, having at least one polymerizable double bond, and a first crosslinker having at least two polymerizable double bonds; (b) a second gel component comprising a second monomer, oligomer, polymer, or combination thereof, having at least one pendant functional group per repeat unit, and a second crosslinker having at least two functional groups, each capable of reacting with the at least one pendant functional group of the second monomer, oligomer, polymer, or combination thereof; and (c) an aqueous solvent. Advantageously, the first gel component and the second gel component form a full interpenetrating polymer network when polymerized, crosslinked, or both polymerized and crosslinked.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

In order that the present invention may be more clearly understood, specific forms will be described with reference to the following drawings and examples.

### BRIEF DESCRIPTION OF THE DRAWINGS

FIG. 1 shows migration ratios of Kaleidoscope Pre-stained Standards in 10% M 2% X acrylamide gel cassette synthesized in water, aqueous solutions of ethylene glycol 20 (25%) or propylene glycol (25%).

FIG. 2 shows migration ratios of SDS-PAGE Molecular Weight Standards (board range) in 10% M 2% X acrylamide gel cassette synthesized in water, or aqueous solutions of poly(ethylene glycol).

FIG. 3 shows migration ratios of SDS-PAGE Molecular Weight Standards (board range) in 10% M 2% X acrylamide gel cassette synthesized in water or aqueous solutions of tri(ethylene glycol) and poly(ethylene glycol).

FIG. 4 shows migration ratios of Kaleidoscope Prestained Standards in 10% M 2% X acrylamide gel cassette synthesized in water and aqueous solutions of tri(ethylene glycol).

FIG. 5 shows turbidity results of polymers synthesized according to Example 29.

FIG. 6 shows turbidity results of polymers synthesized according to Example 30.

FIG. 7 shows turbidity results of polymers synthesized according to Example 31.

FIG. 8 shows turbidity results of polymers synthesized according to Example 32.

FIG. 9 shows turbidity results of polymers synthesized according to Example 33.

FIG. 10 shows turbidity results of polymers synthesized according to Example 34.

FIG. 11 shows turbidity results of polymers synthesized according to 10 Example 35.

FIG. 12 shows turbidity results of polymers synthesized according to Example 36.

FIG. 13 shows turbidity results of polymers synthesized according to Example 37.

FIG. 14 shows turbidity results of polymers synthesized according to Example 38.

FIG. 15 shows the separation and migration pattern of Bovine serum albumin (MW 67,000) by a 15% M 4% X HEMA/EGDMA membrane synthesized in 80% aqueous PEG 200 solution (Example 41) using 40 mM MES bis-TRIS buffer.

FIG. 16 shows turbidity results of polymers synthesized according to Example 56.

FIG. 17 shows a schematic diagram of the formation process of 20% M acrylamide hydrogels in the presence of water and a water-soluble entity. Line E represents systems with 0% X; line F, 2% X; line G, 3% X; line H, 10% X.

FIG. 18 shows real-time viscosity measurements of the polymerization of 20% M acrylamide solutions, in the presence of 17.5% PEG-400, at various % X. Time at which phase separation was observed in the samples are represented by dark colored points (circle).

FIG. 19 shows turbidity measurements of 20% M 2% X acrylamide hydrogels 30 synthesized in the presence of various amounts of PEG-400.

FIG. 20 shows the critical propylene glycol concentrations for the formation of visually hydrogels at various % M and % X.

FIG. 21 shows real-time viscosity measurements of the polymerization of 20% M 2% X HEMA solutions in the presence of various amounts of propylene glycol. Times at which phase separation was observed in the samples are represented by dark colored points (circle).

FIG. 22 shows SEM images (10,000×) of cross-sectional interior of swollen 10% M 2% X acrylamide hydrogels synthesized in water (A), 50% ethylene glycol solution (B), and 50% propylene glycol solution (C).

FIG. 23 shows turbidity measurements of semi-IPNs of pHEMA (20 wt % total monomers, 2 mol % cross-linker) synthesized in the presence of various amounts of PEODGE.

FIG. 24 shows the EWCs of semi-IPNs of pHEMA (20 wt % total monomers, 2 mol % cross-linker) synthesized in the presence of various amounts of PEODGE.

FIG. 25 shows the EWCs of full IPNs (20 wt % monomers, 2 mol % cross-linker HEMA/EGDMA, 2 mol % of EDA per mol of PEODGE, method B) prepared in the presence of various PEODGE/PEG-400 mixtures. Visually clear gels are represented by solid bars and visually opaque gels by shaded bars.

FIG. 26 shows the ESCs of full IPNs containing 35% PEODGE-620 (made according to Method B and containing 2 mol EDA crosslinker per mol of PEODGE) and amounts of HEMA ranging from about 20 to about 50% M, in combination with 2% X EGDMA crosslinker. The initial solvent content reflects the content of isopropyl ether, which was exchanged with water through a solvent exchange process to yield the ESC (water) values.

### MODE(S) FOR CARRYING OUT THE INVENTION

Novel formulations for HEMA hydrogel synthesis—The present inventors have developed a new synthesis method using a mixture of water and water-miscible entities as the polymerization solvent such that HEMA hydrogels can be crosslinked with ethylene glycol dimethacrylate (EGDMA) using low initial monomer content (5-50%). Using water-miscible entities such as polymers with repeating ethoxylated and propyoxylated units (e.g. poly(ethylene glycol) and, polypropylene glycol) or random or block copolymers of polyethylene glycol) at a polymeric-additive glycol-water ratio of about 9:1 to 1:9), hydrogels based on HEMA were successfully formed having higher water swelling properties and bigger pore sizes than those produced previously. Such hydrogels can be subsequently used as synthesized or after the water-miscible entities have been displaced with water. This result is unexpected, given that it is well known that high concentrations of hydrophilic polymer (i.e. poly(ethylene glycol) and poly(propylene glycol)) in acrylamide hydrogel synthesis would lead to phase separation of the reaction mixture. For example, Righetti (Righetti, P. G Chromatogr. A 1995, 698, 3) observed that when acrylamide hydrogels were synthesized in the presence of PEG 2000-20,000, turbid gels (phase separation) were produced and was a function of both length and concentration of the polymer. It was observed that longer polymer chains induce phase separation at lower concentration; all gels become turbid when the PEG concentration in the solvent exceed 10 wt %.

It was also discovered by the present inventors that as the molecular weight of the water-miscible entities increases, the pore size of the hydrogels becomes dependent upon the properties of the entities, with the entities acting as a “template”. In high molecular weight solvents, hydrogels synthesized in solutions of high molecular weight entities were observed to swell more than that of lower molecular weight. To our knowledge, this is the first system in which the templating system is also acting as the solvent for the hydrogel.

Multimodal hydrogels—Utilizing the templating and the solvent properties of the water-miscible entities, it was discovered that multimodal HEMA hydrogels can be obtained by careful selection of the concentrations of monomer, the crosslinking extent, and the types and concentrations of water miscible entities in a one-step process. Two general types of pores exist in such membranes—macropores formed by the template, and micropores formed by the crosslinking of polymer chains. Dependent upon the concentrations of the water-miscible entitles, the macropores in the hydrogel can be continuous (i.e. interconnected), or non-continuous.

Derivatives of monomers such as the poly(alkylene glycol) esters of acrylic or methacrylic acid can also be used in the same manner as HEMA to prepare hydrogels with multimodal channels.

Such hydrogels are different from these synthesized by Zewert and Harrington (U.S. Pat. No. 5,290,411 and U.S. Pat. No. 5,290,411) because:

i) Their teaching indicates that the pore size of the gel is dependent upon the types and concentration of monomer and crosslinkers. Pore sizes of hydrogels according to the present invention are not only dependent upon the types and concentration of monomer and crosslinkers but also dependent upon the size of the water-miscible entities;

ii) The present hydrogels have two types of pores within its network, macropores and micropores;

iii) In the patent of Zewert and Harrington, organic solvents were added mainly for the usage of the resultant gel in organic electrophoresis and were not subsequently replaced with water. In the present invention, the water-miscible entities are acting both as a solvent and a template, and are subsequently exchanged with water.

Applications—HEMA hydrogels made with the above formulations are particularly well-suited for use as separation membranes for biomolecules. Other related areas of interest include biocompatible applications such as prosthetic devices, drug releases matrixes, and tissue scaffolds.

Membrane-Based Electrophoresis—A number of membrane-based electrophoresis apparatus developed by Life Therapeutics Limited (formerly Gradipore Limited), Australia were used in the following experiments. In summary, the apparatus typically included a cartridge which housed a number of membranes forming two chambers, cathode and anode connected to a suitable power supply, reservoirs for samples, buffers and electrolytes, pumps for passing samples, buffers and electrolytes, and cooling moans to maintain samples, buffers and electrolytes at a required temperature during electrophoresis.

The cartridge contained three substantially planar membranes positioned and spaced relative to each other to form two chambers through which sample or solvent can be passed. A separation membrane was positioned between two outer membranes (termed restriction membranes as their molecular mass cut-offs are usually smaller than the cut off of the separation membrane). When the cartridge was installed in the apparatus, the restriction membranes were located adjacent to an electrode. The cartridge is described in AU 738361, which description is incorporated herein by reference.

Description of membrane-based electrophoresis can be found in U.S. Pat. No. 5,039,386 and U.S. Pat. No. 5,650,055 in the name of Gradipore Limited, which descriptions are incorporated herein by reference.

Polyacrylamide Gel Electrophoresis (PAGE)—Standard. PAGE methods were employed as set out below.

Reagents: 10×SOS Glycine running buffer (Gradipore Limited, Australia), dilute using Milli-Q water to 1× for use; 1×SDS Glycine running buffer (29 g Trizma base, 144 g Glycine, 10 g SDS, make up in RO water to 1.01); 10×TBE 11 running buffer (Gradipore), dilute using Milli-Q water to 1× for use; 1×TBE 11 running buffer (10.8 g Trizma base, 5.5 g Boric acid, 0.75 g EDTA, make up in RO water to 1.01); 2×SDS sample buffer (4.0 ml, 10% (w/v) SDS electrophoresis grade, 2.0 ml Glycerol, 1.0 ml 0.1% (w/v) Bromophenol blue, 2.5 ml 0.5M Tris-HCl, pH 6.8, make up in RO water up to 10 ml); 2× Native sample buffer (10% (v/v) 10×TBE II, 20% (v/v) PEG 200, 0.1 g/l Xylene cyanole, 0.1 g/I Bromophenol blue, make up in RO water to 100%); Coomassie blue stain (Gradipure™, Life Therapeutics Limited). Note: contains methanol 6% Acetic Acid solution for de-stain.

Molecular weight markers (Recommended to store at −20° C.): SDS PAGE (e.g. Sigma wide range); Western Slotting (e.g. color/rainbow markers). SDS PAGE with non-reduced samples.

To prepare the samples for running, 2×SIDS sample buffer was added to sample at a 1:1 ratio (usually 50 μl/150 μl) in the microtiter plate wells or 1.5 ml tubes. The samples were incubated for 5 minutes at approximately 100° C. Gel cassettes were clipped onto the gel support with wells facing in, and placed in the tank. If only running one gel on a support, a blank cassette or plastic plate was clipped onto the other side of the support Sufficient 1×SDS glycine running buffer was poured into the inner tank of the gel support to cover the sample wells. The outer tank was filled to a level approximately midway up the gel cassette. Using a transfer pipette, the sample wells were rinsed with the running buffer to remove air bubbles and to displace any storage buffer and residual polyacrylamide.

Wells were loaded with a minimum of 5 pi of marker and the prepared samples (maximum of 40 μl). After placing the lid on the tank and connecting leads to the power supply the gel was run at 150V for 90 minutes. The gels were removed from the tank as soon as possible after the completion of running, before staining or using for another procedure (e.g. Western blot).

Staining and De-staining of Gels—The gel cassette was opened to remove the gel which was placed into a container or sealable plastic bag. The gel was thoroughly rinsed with tap water, and drained from the container. Coomassie blue stain (approximately 100 ml Gradipure™, Life Therapeutics Limited, Australia)) was added and the container or bag sealed. Major bands were visible in 10 minutes but for maximum intensity, stained overnight. To de-stain the gel, the stain was drained off from the container.

The container and gel were rinsed with tap water to remove residual stain. 6% acetic acid (approximately 100 ml) was poured into the container and sealed. The de-stain was left for as long as it takes to achieve the desired level of de-staining (usually 12 hours). Once at the desired level, the acetic acid was drained and the gel rinsed with tap water.

Size exclusion electrophoresis—Compared to column chromatography, which normally involve high pressure drops and compaction for soft gels at high flow rates, membrane chromatography has a lower pressure drop, high flow rate and high productivity as result of microporous I macroporous structures in relatively thin membranes.

As described above, protein separations under electrophoresis with a separation membrane are normally either size or charge based, which have limitations of its own such as the range of proteins can be separated. The present inventors have introduced the concept of protein or other compound separation under size exclusion chromatography principle using electrophoresis. By using this concept, protein or compound can be separated in an opposite manner to conventional electrophoresis and some large biomolecules, which are not able to be separated by existing systems, have been purified by this process.

The basic requirements for a SE separation are that the separation medium contains at least two types of pores: macropores and micropores. In chromatography, the large molecules will go though the big pores and travel fast while the smaller molecules will have interaction with small pores due to its compatible size with the micropores. Therefore in the separation of polymers by using size exclusion chromatography, polymer with largest molecular weight will elute out of a separating column first and the one with the smallest molecular weight will elute out last.

In the design of the SE hydrogel matrix systems, the present inventors have adopted the same principle. The solvent system used can act both as a porogen arid a solvent to the amphiphilic monomer. The monomers used produce network structures with functional groups and these functional groups can interact with small proteins as these molecules enter the small pore structure.

The hydrogels can be used in two different ways by utilizing the recently developed Gradiflow™ system to test the separation of the resultant membranes; one 25 way is for the manufacture of membranes with a larger pore size or with improved functionality. The other is SE hydrogel electrophoresis. Membranes with larger pore size can be tested in the following way the membrane will be placed in the middle of a separation cartridge in a separation unit. The protein mixture to be separated will be placed in stream 1. When the charge is applied, the separation will begin and small proteins will travel to stream 2 through the membranes.

When SE type membrane is used, it is placed in the middle of a separation cartridge in a separation unit. The protein mixture to be separated will be placed in stream 1. When the electric potential is applied, the separation will begin and large proteins will travel to stream 2 through the SE-type membranes. With the increase of time, small proteins may saturate the small pores of the separation membrane and the process needs to be pulsed to release the small proteins back to the upstream. This process can be carried out by removing separated proteins from stream 2 and reverse the potential supplied.

Definitions

The following terms shall have the indicated definitions unless otherwise indicated: “Hydrogen” is a chemically crosslinked polymer characterized by hydrophilicity and insolubility in water.

“Micropores” are pores within the gel network of the background matrix. The size of these pores can be related to the hydrogel formation species in the initial pre-gelling mixture using relationships and theories developed for common electrophoretic matrixes.

For example, micropores within an acrylamide hydrogel are related to the total monomer concentration and monomer to crosslinker ratios in the free radical polymerization of acrylamide and N,N′-methylenebisacrylamide (Bansil, R.; Gupta, M. Ferroelectrics 1980, 30, 64).

“Macropores” are pores within the membrane that are significantly larger (more 20 than 2 times) than micropores of the background matrix.

“Microporous membrane” is a separation membrane having substantially continuous interconnecting micropores. Such membranes are used extensively in preparative electrophoresis.

“Macroporous membrane” is a separation membrane having continuous interconnecting micropores but non-continuous macropores (i.e. macropores are not connected directly to each other). Such membranes have similar sieving properties to the corresponding microporous membrane, but allows for higher flow rate through the matrix because of the reduced diffusional constraints.

“Size exclusion membrane (SE-Mem)” is a bi, or multimodal separation membrane having continuous interconnecting micropores, and interconnecting macropores within its matrix. SE-Mem can have different separation behaviours depending upon the size of the micropores (S_{mic}), the size of the macropores (S_{mac}) and the size of the bio-molecule mixture (S_{bio}). When S_{bio}>S_{mac}>S_{mic}, no separation would occur; when S_{mac}˜S_{bio}>S_{mic}, all molecules with dimension smaller than the macropores would be separated from their bigger counter part; when S_{mac}>S_{bio}˜S_{mic}, all molecules with dimension smaller than the macropores would be separated from their bigger counter part, and be eluted in the order of decreasing size.

From the above description of SE-Mem, the challenge in producing such membrane lies in i) increase the size exclusion limit, i.e. the size of the largest interconnecting pores, and ii) produce a polymer with both interconnecting micropores and macropores. It would be a substantial advantage to develop a simple process to synthesis such membrane.

Multi-modal HEMA hydrogels are suitable to be used as SE-Mem as two general types of pores exist in such membrane—macropores formed by the template or porogen, and micropores formed by the crosslinking of polymer chains. The size exclusion limit of such membrane is also increased because of the macropores. SE-Mem can be used in membrane based electrophoresis techniques and as membrane support for membrane chromatography and affinity membrane chromatography. It can take the form of flat sheet, stacked sheet, radical flow cartridges, hollow fiber molecules, slab, and column.

The term “stream 1 (S1)” refers to denote the first interstitial volume where sample is supplied in a stream to the electrophoresis apparatus. This stream may also be called the “upstream”.

The term “stream 2 (S2)” is used in this specification to denote the second interstitial volume where material is moved from the first interstitial volume through the separation membrane to a stream of the electrophoresis apparatus. This stream may also be called the “downstream”.

The term “forward polarity” is used when the first electrode is the cathode and the second electrode Is the anode in the electrophoresis apparatus and current is applied accordingly.

The term “reverse polarity” is used when polarity of the electrodes Is reversed such that the first electrode becomes the anode and the second electrode becomes the cathode.

As used herein, the term “polymerizable double bond” should be understood to mean a double bond that can be propagated by conventional free radical and/or redox initiation and polymerization techniques under a standard or conventional (solvent, temperature, etc.) conditions. For example, while the pi bonds of a phenyl ring are represented as alternating double and single bonds, they are not traditionally or conventionally polymerizable except under relatively extreme conditions; however, the vinyl group of a styrene monomer, for instance, is such a polymerizable double bond.

Abbreviations

Acrylamide (AAm); N,N′-methylenebisacrylamide (BIS); poly(acrylamide) gel electrophoresis (PAGE); 2-hydroxyethyl acrylate (HEA); 2-hydroxyethyl methacrylate (HEMA); poly(ethylene glycol) acrylate (PEGA); poly(ethylene glycol) methacrylate (PEGMA); ethylene glycol diacrylate (EGDA); ethylene glycol dimethacrylate (EGDMA); poly(ethylene glycol) acrylate (PEGA); poly(ethylene glycol) methacrylate (PEGMA); poly(ethylene glycol) diacrylate (PEGDA); polyethylene glycol) dimethacrylate (PEGDMA); polyethylene glycol) PEG; and polypropylene glycol) PPG; poly(ethylene glycol) methyl ether PEGME; N,N,N′N′-tetramethylethylenediamine (TEMED); ammonium persulfate (APS); α,ω-diglycidyl-poly(ethylene oxide) (PEODGE); ethylenediamine (EDA).

Introduction to Full IPN PHEMAs

Visually clear 2-hydroxyethyl methacrylate (HEMA) hydrogels are usually prepared by the free radical copolymerization of HEMA and a cross-linking agent at low dilutions (<40-45%) of water. These gels have been largely employed in biomedical applications and as separation or adsorption matrixes for various metal ions; however, the wider usage of such gels in aqueous media is restricted because of their limited water intake. Furthermore, the pore sizes (0.5-5 nm) of these gels are severely limited by their high polymer contents, which lead to increasing interpenetration of polymer chains during network formation.

To improve the water-sorption characteristics of these gels, monomers that are more hydrophilic than HEMA, such as poly(ethylene glycol)methacrylate, vinylpyrrolidone, and various ionic or zwitterionic monomers, can be used to partly replace HEMA in the reaction mixture. Although the swelling characteristics of these copolymers are generally improved, the preparations of such gels are complicated by factors which include the different relative reactivities of the monomers.

An alternative approach to modify the swelling behavior of these networks is to prepare interpenetrating polymer networks (IPNs) of poly(2-hydroxyethyl methacrylate) (PHEMA) and polymers that are more hydrophilic than PHEMA. Semi-IPNs of PHEMA have been prepared in the presence of hydrophilic polymers such as poly(ethylene glycol), poly(ethylene glycol) dimethyl ether, and poly(vinylpyrrolidone). These networks have improved swelling properties but limited uses in aqueous medium, because, when the networks are placed in water, the hydrophilic linear polymers can diffuse out of the gel matrix. This can result in undesirable volume transitions of the gels and the introduction of unwanted compounds into the surrounding medium. In contrast, there have been relatively few studies on the preparation of full IPNs of PHEMA that utilize hydrophilic polymers as the IPN agent. In these studies, the hydrophilic polymer is poly(vinyl alcohol) or gelatin. Because both of these polymers have limited compatibility with PHEMA, visually clear networks have only been obtained when the HEMA content of the reaction mixture is >40%.

In the present work, the synthesis of full IPNs based on cross-linked PHEMA and cross-linked poly(ethylene oxide) diglycidyl ether (PEODGE) is described; the first polymer network is formed by the free-radical copolymerization of HEMA and ethylene glycol dimethacrylate (EGDMA) (Scheme 1) and then the second network by coupling reactions between PEODGE and ethylenediamine (EDA) (Scheme 2).

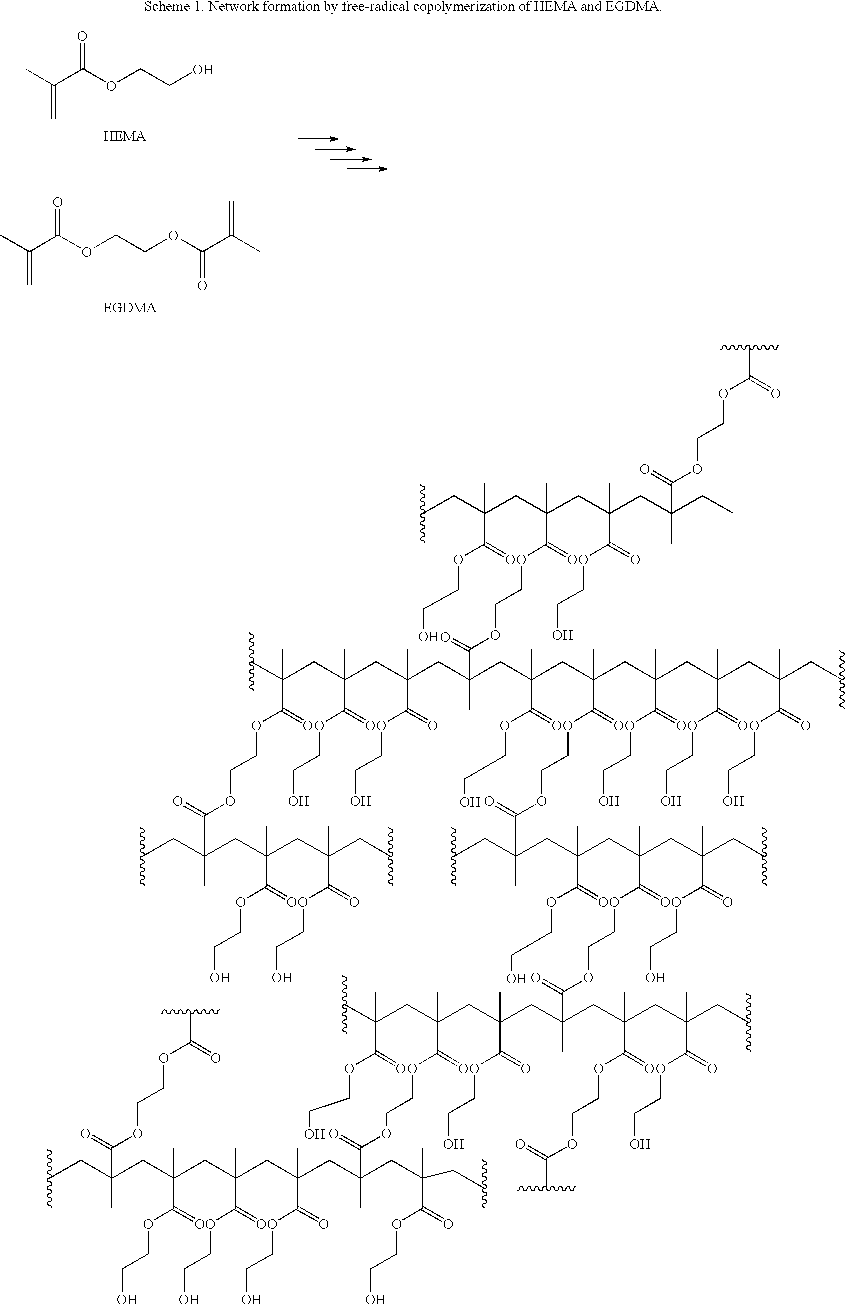

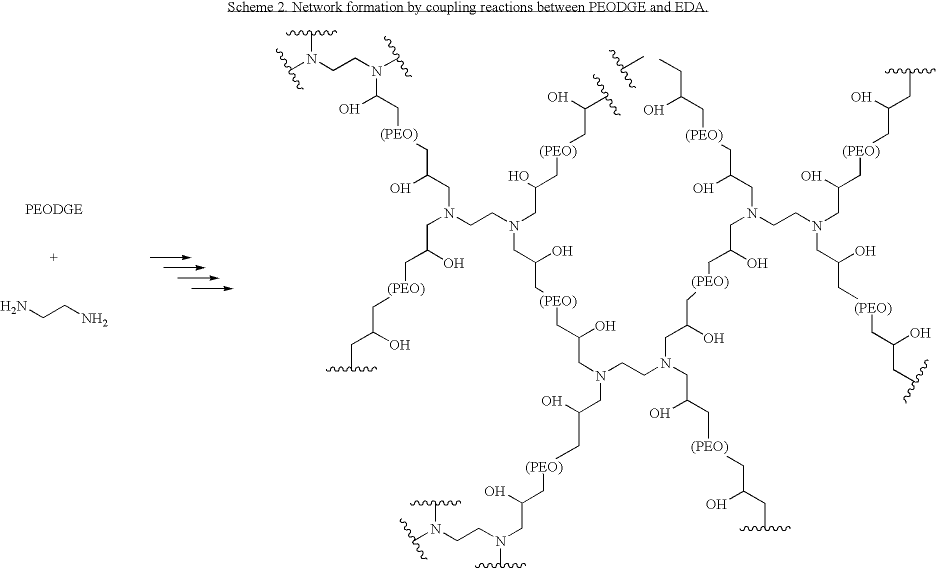

When compared to other existing PHEMA networks, visually clear polymers are obtained at significantly lower total monomer concentrations; the resultant networks obtained from this new approach also have very different swelling and porous properties, which can overcome some of the disadvantages described above.

Materials and Methods

Materials.

HEMA (97%), EGDMA (98%), PEODGE (MW=530), poly(ethylene glycol) (PEG; MW=400), EDA (>99.5%), N,N,N′,N′-tetramethylethylenediamine (TEMED; ×99.5%), ammonium persulfate (APS, >99.5%), isopropyl ether (IPE, >99%), and benzoic acid were purchased from Aldrich Fine Chemicals (Castle Hill, NSW, Australia). N,N-Dimethylformamide (DMF), hydrochloric acid (HCl, 37% in water), and sodium hydroxide were obtained from AJAX FineChem (Seven Hills, Australia). HEMA and EGDMA were filtered through an activated basic alumina column, distilled under reduced pressure, and stored at 4° C. The epoxy content of the PEODGE sample was determined to be 3.22 (±0.01)×10⁻³ s mol/g by standard HCl titration in DMF, which gave a number-average molecular weight of 620 when each poly(ethylene oxide) (PEO) chain was assumed to have two epoxy end groups. All other reagents, unless specified, were of analytical grade and were used without further purification, and distilled water was used at all times. The monomer solutions are classified according to their monomer contents (wt % total monomers in the reaction mixture) and cross-linker content (mol % cross-linker in the monomer mixture). The PEODGE concentration of the reaction mixtures is given in weight percentage. The actual functionality (fₐ) of EDA and PEODGE in the coupling reactions is defined as
fₐ(A)=[total number of functional groups on A that can react]/[number of molecules A in system] (1a)
For example, the actual functionality of EDA when reacting with PEODGE is given in the following equation:
fₐ(EDA)=(functionality of PEODGE)*[EDA]/[PEODGE]=2*[EDA]/[PEODGE] (1b)

Preparation of Semi-I IPNs.

Monomer solutions (5 g) were prepared by mixing HEMA and EGDMA in the appropriate amount of PEODGE solution in water (% PEODGE is calculated according to the weight of PEODGE in the final reaction mixture) in disposable glass vials. The mixture was degassed by argon purging prior to the addition of the initiator system (0.1 mol % initiator/mol of double bonds) composed of freshly made 10% (v/v) TEMED and 10% (w/v) APS. The polymerization was then allowed to proceed at room temperature overnight under an argon atmosphere.

Preparation of Full IPNs.

Semi-IPNs prepared according to the above procedures were (1) placed in isopropyl ether (IPE) solutions of EDA (50 ml, 2 mol of EDA/mol of PEODGE) for 96 hours at 30° C. (method A) or (2) placed in IPE (50 ml) and equilibrated to 30° C., after which EDA was added over 10 hours, at 2-hour intervals (5×0.2 mol of EDA/mol of PEODGE, followed by 1 mol of EDA/mol of PEODGE), and kept at constant temperature for a further 86 hours (method B).

Turbidity Measurements.

Monomer solutions (10 g) were prepared according to the above procedure. After the addition of the initiator system, two 3.75 mL samples were pipetted into disposable cuvettes (10×10×45 mm³), and the polymerization was then allowed to proceed at room temperature overnight under an argon environment.

Turbidity measurements of the resultant gels were made using UV-vis spectrophotometry, Distilled water was used for the baseline, and the absorbance of each gel sample was recorded at 600 nm. Turbidity (τ) is defined by the equation I/Iₒ=exp(−τx), where Iₒ and I are the initial and final light intensities transmitted through the sample and x is the sample length. The adsorption of the sample, A, is defined by the equation A=(Iₒ/I). Therefore, the turbidity of the gel samples was finally determined by the following equation:
τ=−[ln(10^{-A})] (2)

Swelling Studies.

Polymers made according to the above procedure were immersed in water for 1 week, during which the immersing solutions were exchanged on a daily basis. The gels were then dried in a 40° C. regular oven for 1 week. The equilibrium water content (EWC) of the gels was determined according to Equation 3. The gel yield of the reactions was calculated from the weight of the dried gel.
EWC=[weight(swollen gel)−weight(dried gel)]/[weight(dried gel)] (3)

Cryo Scanning Electron Microscopy (Cryo-SEM) Analysis.

After equilibration in water, a piece of the hydrogel (5 mm×5 mm) was mounted vertically onto an SEM stub and cryogenically fractured in liquid nitrogen. The water from the fractured surface of the gel was sublimed at −60° C. for 60 minutes. The gel was then cooled to −190° C., and images of the fractured polymer were taken using an XL30 field emission scanning electron microscope.

Results and Discussion

The general procedure for the preparation of the IPNs is schematically shown in Scheme 3.

[image]

Scheme 3. Schematic Diagrams Representing the Preparation of pHEMA/PEO IPNs: (i) semi-IPN formed by the free radical polymerization of HEMA and EGDMA in aqueous PEODGE solutions; (ii) final full IPN prepared by coupling reactions between PEODGE and EDA, which is diffused into the gel from immersing solution.

In the first step, HEMA and EGDMA are copolymerized in an aqueous solution of PEODGE. After the formation of the semi-IPN, the gel is placed in an IPE solution of EDA. Upon the diffusion of EDA into the interior of the gel, the amino hydrogens can react with the epoxy rings of PEODGE, resulting in the formation of a hybrid class of sequential and simultaneous full IPN.

Semi-IPNs of PHEMA.

In contrast to the use of water as solvent for HEMA polymerization, the use of suitable hydro-organic mixtures as polymerization solvent can result in the formation of clear hydrogels at low initial monomer contents (<60%) due to the ability of the organic solvent to solvate the polymer chains throughout the polymerization. The organic component of these polymerization solvents can be selected on the basis of its solubility parameter (δ). It was found that, at high water dilutions, the formation of a visually clear hydrogel is promoted by the use of an organic component that has a δ similar to or lower than that of PHEMA.

Poly(ethylene oxide)s (δ˜24.2 MPa^{0.5}) have a d similar to that of PHEMA (δ˜26.93 MPa^{0.5}); PEODGE is therefore chosen as the IPN agent because, first, it can act as part of the polymerization solvent to prepare visually clear semi-IPNs of PHEMA at low monomer contents and, second, it is well-known that the extent of swelling of a polymer is related to the difference between its d and that of the swelling solvent. The final PEO network (formed after the subsequent PEODGE coupling reactions) of the full IPNs is therefore expected to provide solvation to the PHEMA network.

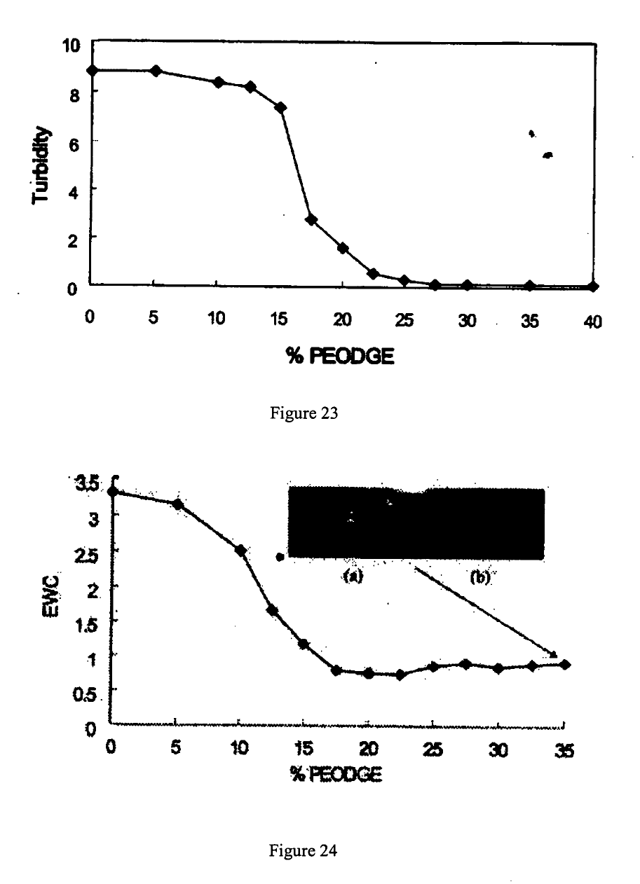

Semi-IPNs of PHEMA (20 wt % monomers, 2 mol % cross-linker) were prepared at various % PEODGE values and their turbidities measured to monitor the extent of polymerization-induced phase separation in the samples, and to provide guidelines for the preparation of clear semi-IPNs. See FIG. 23. The results demonstrate the ability of PEODGE to solvate PHEMA chains formed during the polymerization; visually clear hydrogels can be obtained when the reaction mixture contains more than 25% PEODGE.

The degree of swelling observed at equilibrium, as represented by the EWC of the polymer via Equation 3, is a representation of the competition between the entropy of dilution, gained by the added volume of the polymer throughout which the solvent may spread, and the elasticity of the polymer network as well as the heat of mixing. EWCs of water-swollen semi-IPNs are shown in FIG. 24. The degree of swelling is significantly higher when the reaction mixture contains low amounts of PEODGE; it first decreased with increasing PEODGE content until ˜20%, and then remained at an approximately constant EWC value at higher PEODGE concentrations.

The swelling properties of the opaque polymers are similar to those reported previously and to those of the PHEMA gels obtained by Dusek and Sedlacek and by Chirila et al. in pure aqueous systems. Their enhanced swellings were ascribed to variations in the dimensions of the polymeric network caused by the phase separation process. More importantly, FIG. 24 also demonstrates that the clear gels formed in the absence of phase separation have a narrow range of EWCs (˜0.8-0.95). The volume transitions of these gels are illustrated by the case where the semi-IPN is synthesized in the presence of 35% PEODGE before (EWC=4) and after (EWC=0.9) the solvent exchange process. This solvent exchange phenomenon is attributed to changes in the δ of the swelling medium (PEODGE within the gel network has diffused out and is replaced with water).

Coupling Reactions of PEODGE and EDA.

The glycidyl end groups of PEODGE are known to react with amines that contain active hydrogen atoms. In this work, EDA—a compound which contains two primary amine groups—is used as the coupling agent for the formation of the full IPNs.

In step-growth polymerizations, the functionality of a molecule is not simply the number of functional groups in that molecule, but is the number of functional groups that can react in the system under consideration. Therefore, although the potential functionality of EDA is 4 (active amino hydrogen) and that of PEODGE is 2 (epoxy groups), the actual functionality (fₐ) of the molecules is dependent upon the ratio of the two compounds in the system and is defined according to Equation 1. The formation of a three-dimensional polymer network requires the presence of branch units (units with fₐ>2), whereas linear polymers result when both monomers are bifunctional.

The influence of EDA on the coupling system will be discussed by examples in which fₐ(PEODGE) is kept at 2. This is achieved when the systems have at least 1 mol of amino hydrogen per mol of epoxy, such that all epoxy groups on PEODGE can be reacted.

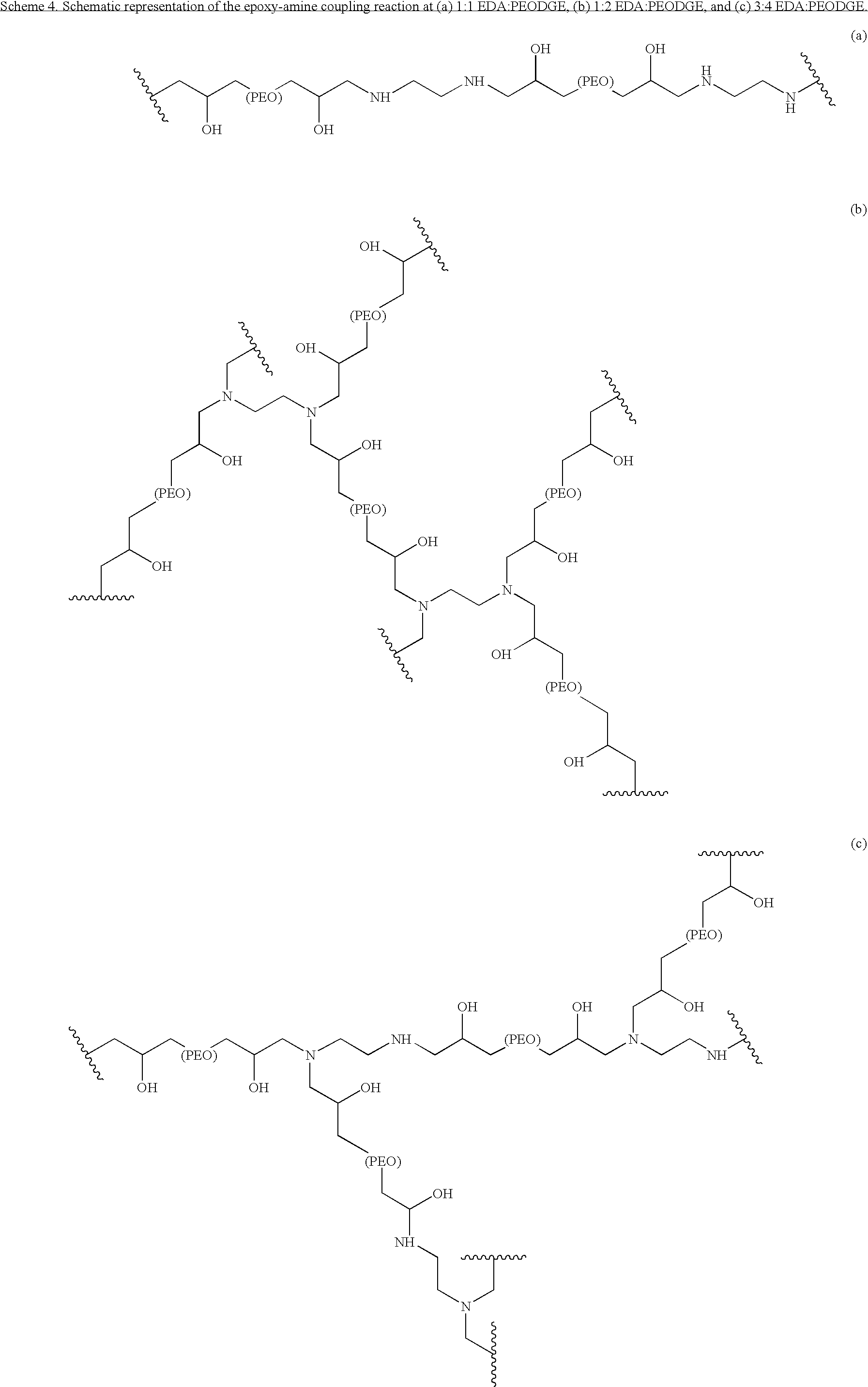

When there is 2 mol of amino hydrogen available for every mole of epoxy (i.e., 1:1 EDA:PEODGE; Scheme 4a), fₐ(EDA) is decreased to 2 because only half of the amino hydrogen can react and linear polymers are therefore expected to form in the reaction mixture. On the other hand, the formation of three-dimensional networks occurs when fₐ(EDA) is >2. The tightest gel network is expected to form when there is 1 mol of amino hydrogen per mol of epoxy (i.e., 1:2 EDA:PEODGE; Scheme 4b); fₐ(EDA) is 4 in this system, and networks with tetrafunctional cross-linked points are expected. The porosity and flexibility of the networks are expected to increase with decreasing fₐ(EDA). For example, when there is 1.5 mol of active hydrogen available for every mole of epoxy group (i.e., 3:4 EDA:PEODGE; Scheme 4c), fₐ(EDA) is decreased to 3 and networks with trifunctional branched points are obtained.

To investigate the effects of PEODGE and EDA on the coupling reactions, various PEO networks were prepared (in the absence of HEMA and EGDMA) by reacting PEODGE and EDA at different dilution of water. The products from these reactions are transparent hydrogels, which are similar to the PEO hydrogels obtained by cross-linking PEG with diisocyanates.

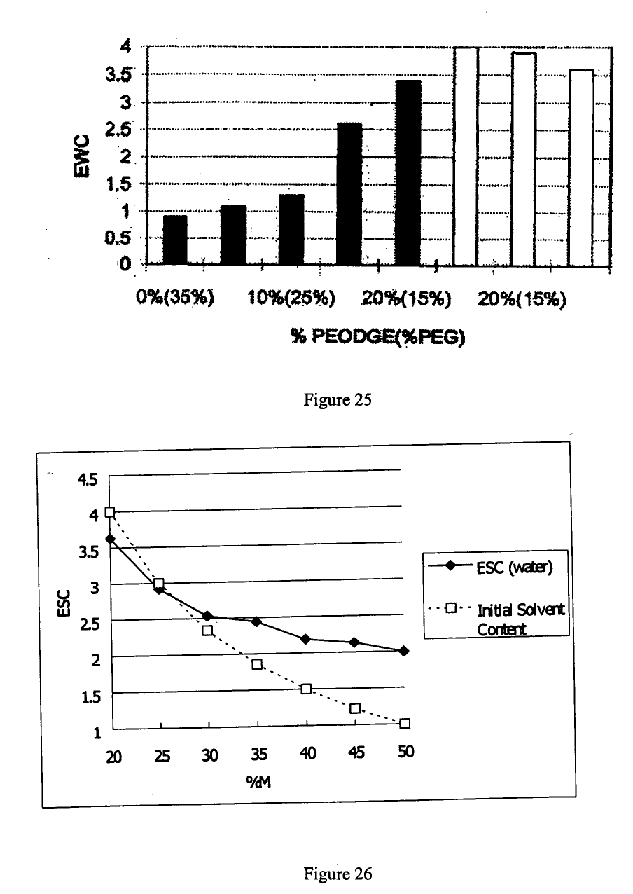

FIG. 25a shows the EWC of water-swollen PEODGE hydrogels prepared at various % PEODGE values, when the number of moles of EDA per mole of PEODGE is varied from 0.5 to 1 such that fₐ(EDA) is decreased from 4 to 2 while fₐ(PEODGE) is kept at 2. At the same fₐ(EDA), the EWC of the gels was observed to decrease with increasing % PEODGE, which is consistent with the increasing network density of the gels. The gel yields of the reaction mixture are shown in FIG. 25b, and were observed to follow a trend similar to that of the EWC values,

In contrast to the theoretical predictions, minimum EWC values were not obtained when fₐ(EDA) was 4, but when it was 3.6, which can be attributed to the restricted mobility of the functional groups in the post gel reaction period. On the other hand, FIG. 25b shows that (1) significant amounts of cross-linked gel products were obtained at fₐ(EDA)=2, when linear polymers were expected, and (2) the gel yields of the reaction mixtures decreased with decreasing fₐ(EDA) when the functionality was between 3.6 and 2.4, when the systems were expected to produce cross-linked polymers with different extents of swelling but similar gel yields. These two observations suggest that the calculated fₐ(EDA) is in fact an average of a distribution composed of EDA units with higher and lower functionality; PEO chains coupled with EDA units of high functionalities (>2) form the gel network, while those coupled with EDA units of low functionalities (≦2) form soluble polymers which do not constitute part of the polymer network. The broad distribution of fₐ(EDA) can occur if the epoxy-secondary amine reactions are significantly faster than the epoxy-primary amine reactions (i.e., a positive kinetic substitution effect). Although it has been reported that in aliphatic amines the primary and secondary amino hydrogens have closely similar reactivities, the observed positive substitution effect can be caused by other factors either thermodynamic or kinetic, for example, the localization of PEODGE chains in the reaction mixture.

Full IPNs of PHEMA and PEO.

To prepare the full IPNs, semi-IPN PHEMA networks (20 wt % monomers, 2 mol % cross-linker) were formed in the presence of 35% PEODGE and then the PEO chains coupled with EDA. In the first set of experiments (method A), the gels were placed in IPE solutions which contain various amounts of EDA (0-8 mol of EDA/mol of PEODGE). Owing to the low solubility of EDA in IPE, all the IPE solutions are slightly turbid. At the end of the reactions, the initially turbid solutions became clear, which indicated the diffusion of EDA into the interior of the gel.

Polymer networks prepared according to the above procedure were equilibrated in water and their EWCs determined, as shown in the table below.

EWCs of Full IPNs (20 mol % Monomer, 2 mol % Cross-Linker
HEMA/EGDMA, 35% PEODGE, Method A) Prepared With
Varying Amounts of EDA in Immersing Solution

| n(EDA)/ | | n(EDA)/ | | n(EDA)/ | |
|---|---|---|---|---|---|
| n(PEODGE) | EWC | n(PEODGE) | EWC | n(PEODGE) | EWC |
| 0.25 | 2.0 | 1 | 2.87 | 6 | 3.15 |
| 0.5 | 2.11 | 2 | 3.10 | 8 | 3.09 |
| 0.75 | 2.54 | 4 | 3.14 | | |

It can be seen that coupling of PEODGE chains within the hydrogel network leads to significant increases in the degree of swelling; the EWCs of the gels first increase with increasing amounts of EDA in the immersing solution and then remain approximately constant at around 3.0-3.2 when there is 2 mol of EDA/mol of PEODGE. The high water intake of these gels can be attributed to the hydrophilicity of the PEO network, and the favorable interactions between PEO and PHEMA, which reduce the hydrophobic interactions between PHEMA chains in water.

When low amounts of EDA were used (<2 mol of EDA/mol of PEODGE), IPNs with significantly lower EWCs and collapsed cores were formed because of insufficient coupling of PEODGE chains in the region; during the swelling process, the lightly branched PEODGE chains are removed from the network, which leads to gel shrinkage in the middle of the gel. This phenomenon was not observed at higher EDA concentrations, which indicates the formation of PEO networks throughout the sample.

It is interesting to note that when >1 mol of EDA per mol of PEODGE was used, significant surface cracks (layers of gels being “peeled off” from the exterior) were observed in all the water-swollen IPNs. This phenomenon can be understood in terms of the diffusion process of EDA into the interior of the gel and its influence on the coupling process. The transfer rate of EDA from the bulk solution to the interior of the gel is proportional to the concentration gradient and to the area of the interface; the concentration of EDA is hence expected to be much higher at the exterior of the gel and also at the start of the reaction. The excess amount of amine group at the outer layer of the networks can lead to the formation of various PEO-based polymers that do not constitute part of the gel network because they have EDA units with reduced fₐ. The observations are consistent with results obtained from the previous section, and suggest that the formation of a full PEO network throughout the IPN is favored by the slow diffusion of EDA (≧2 mol of EDA/mol of PEODGE) into the semi-IPN networks. It should be noted that, when compared to results obtained in the preceding section, the amounts of EDA per PEODGE used in full IPN formation are significantly higher than those used in the PEO hydrogel formation. This can be attributed to the incomplete transfer of EDA from the immersing medium to the gel matrix.

In a subsequent set of experiments (method B), the semi-IPN network was placed in IPE, and EDA (overall 2 mol of EDA/mol of PEODGE) added into the solution at regular time intervals to reduce the transfer rate of EDA to the gel. No visible surface cracks were observed on the network that was prepared by this approach. The EWC and gel yield (the percentages of PHEMA and PEODGE chains that are connected to the final gel network) of the network were determined to be 3.6% and 83%, respectively, which indicates the successful incorporation of PEO chains, into the network. Cryo-SEM images of the water-swollen full IPN were taken, and compared to those of the corresponding semi-IPN, to examine the surface morphologies and apparent pore size distributions of the gel networks. When compared to the water-equilibrated semi-IPN samples and also to visually clear PHEMA networks obtained by conventional techniques, the full IPN exhibited much bigger pores and a wider pore size distribution. Particularly, two distinct types of pores—macropores on the order of up to 800 nm and micropores on the order of 50-100 nm—were observed.

Results from FIG. 23 show that, at 20 wt % monomers and 2 mol % cross-linker, visually clear polymers of HEMA can only be formed when the reaction mixture contains more than 25% PEODGE. PEG-400, which has a structure and molecular weight similar to those of PEODGE, was therefore chosen to partly replace PEODGE in the polymerization solvent for the effects of % PEODGE on the swelling properties of the result ant polymer networks to be investigated. In the experiments, visually clear semi-IPN networks of PHEMA were prepared in a range of 35% (PEG-400/PEODGE) mixtures, after which the PEODGEs were coupled by method B (overall 2 mol of EDA/mol of PEODGE). PEG-400 was inert in the coupling reactions and can consequently be washed out from the network matrix during the solvent exchange process.

EWCs of the water-swollen full IPNs are shown in FIG. 25; it can be seen (from the shaded bars) that the IPNs obtained at lower % PEODGE are slightly opalescent. Cryo-SEM images of the water-swollen full IPN were taken to examine the effects of % PEODGE on the surface morphologies and apparent pore size distributions of the gel networks. Results obtained from the cryo-SEM analysis were consistent with those obtained from the above swelling studies; the porosity of the opalescent networks was observed to increase with increasing % PEODGE, while pore sizes on the order of 1 μm were obtained at lower % PEODGE (25%, compared with 35%) for the visually clear networks.

By comparing FIGS. 24 and 25, it can be seen that visually clear semi-IPNs and full IPNs are both obtained when the reaction mixture contains ≧25% PEODGE; this highlights the different levels of solvation of the PEO chains on the PHEMA network during and after the synthesis. EWCs of the visually clear networks (25-35% PEODGE) were found to increase with decreasing % PEODGE, which is consistent with results obtained from the PEODGE-EDA coupling reactions and can be attributed to the decreased network density of the system. On the other hand, EWCs of the opalescent networks (0-20% PEODGE) were found to decrease with decreasing % PEODGE, which is consistent with the expected increasing hydrophobicity of the networks.

Visually clear networks with higher equilibrium water contents and bigger pore sizes than those of conventional HEMA hydrogels can be formed by preparing full IPNs of the polymer and a cross-linkable macromolecular solvent for the polymer. The properties of these networks are very different from those of the corresponding semi-IPNs, and are shown to be dependent upon the EDA and PEO contents of the system. In general, the pore sizes of the networks were observed to decrease with increasing PEODGE content of the reaction mixture, while optimum network formation is promoted by the slow addition of EDA (with ≧2 mol of EDA/mol of PEODGE) into the semi-IPN networks.

### Alternate Embodiments

Another aspect of the invention relates to a solvent-swellable, particularly aqueous solvent-swellable, preferably water-swellable, crosslinked gel having an array of pore sizes and comprising a first gel component that comprises a first monomer, oligomer, and/or polymer with at least one polymerizable double bond and a crosslinker with at least two polymerizable double bonds. Such a crosslinked gel can be a mere crosslinked single-polymer system, a semi-IPN (one polymer crosslinked in the presence of another polymer), or preferably a full IPN (two polymers each crosslinked in each other's presence).

In some embodiments of the invention the crosslinked gels according to the invention can be full IPNs and thus further comprise a second gel component that comprises a second monomer, oligomer, and/or polymer with at least one pendant functional group per repeat unit and a crosslinker with at least two pendant functional groups capable of reacting with the at least one pendant functional group of the second monomer, oligomer, and/or polymer.

In one embodiment, neither the at least one functional group per repeat unit nor any of the at least two functional groups of the crosslinker in the second gel component comprise an isocyanate group or a group that can decompose to form an isocyanate group.

The first monomer, oligomer, and/or polymer can be any monomer, oligomer, and/or polymer known to be polymerizable by conventional free radical and/or redox initiation/polymerization processes. Exemplary first monomers, oligomers, and/or polymers can include and/or be made from, but are not limited to, addition-propagated vinyl monomers having functionalized pendant esters, such as carboxylate esters (e.g., functionalized alkyl acrylates, functionalized alkyl alkacrylates, functionalized vinyl alkyl esters such as functionalized vinyl acetate, or the like, or a combination thereof, or a copolymer comprising same). The functionalized pendant groups can include, but are not limited to, hydroxyls, amines, thiols, phosphonates, sulfonates, nitrates, nitroso groups, nitriles, carboxylic acids, carboxylates, carboxylate esters, amides, or the like. The term “alkyl” and the prefix “alk-” independently indicate straight or branched aliphatic hydrocarbon moieties, each having preferably from 1 to 6 carbons, more preferably from 1 to 4 carbons. Particularly useful first monomers, oligomers, and/or polymers according to the invention can include and/or be made from HEA, HEMA, aminoethylacrylate, aminoethylmethacrylate, or the like, or combinations or copolymers thereof.

The first crosslinker can be any crosslinker having at least two groups (double bonds) known to be polymerizable by conventional free radical and/or redox initiation/polymerization processes. Exemplary first crosslinkers can include and/or be made from, but are not limited to, addition-propagated di- and/or multi-vinyl monomers connected by esters, such as carboxylate esters (e.g., alkylene di- and/or poly-acrylates, alkylene di- and/or poly-alkacrylates, di- and/or poly-vinyl esters such as divinyl oxalate and divinyl succinate, or the like, or a combination thereof, or a copolymer comprising same). Particularly useful first crosslinkers according to the invention can include and/or be made from EGDMA, EGDA, or the like, or a combination thereof.

When present, the second monomer, oligomer, and/or polymer can be any monomer, oligomer, and/or polymer polymerizable by a means/mechanism other than conventional free radical, ionic, and/or redox initiation/polymerization processes or may be a macromonomer (i.e., an oligomer or polymer having multiple repeat units but which also has one or more functional groups, preferably two or more functional groups, that can react to further propagate and/or crosslink the polymeric component, for example, in combination with a crosslinker; such functional groups can include, but are not limited to, hydroxyls, amines, epoxides, thiols, anhydrides, lactones, lactams, carboxylic acids, carboxylates, carboxylate esters, amides, or the like, or combinations thereof). Exemplary second monomers, oligomers, and/or polymers can include and/or be made from, but are not limited to, telechelic/end-capped compounds such as α,ω-diepoxides, and compounds having repeat units with one or more functionalized pendant groups, particularly those that react/propagate/crosslink through a ring opening mechanism and/or by step growth processes. Such compounds can advantageously be compatible with water, preferably at least partially water-miscible, also preferably at least partially water-soluble, e.g., end-capped poly(alkylene ether)s such as α,ω-diglycidyl-PEO. The term “alkylene” indicates straight or branched aliphatic hydrocarbon moieties attached at two points, each moiety having preferably from 1 to 6 carbons, more preferably from 1 to 4 carbons.

When present, the second crosslinker can be any crosslinker having at least two groups polymerizable and/or reactable (e.g., with a macromonomer, as described above) by a means/mechanism other than conventional free radical, ionic, and/or redox initiation/polymerization/crosslinking processes. Exemplary second crosslinkers can include and/or be made from, but are not limited to, di- and/or poly-amines (such as EDA, N-methylethylenediamine or NMEDA, diethylenetriamine, hexamethylenetetramine, diaminohexane, diaminocyclohexane, or the like, or combinations thereof), di- and/or poly-thiols, di- and/or poly-ols (such as ethylene glycol, glycerol, propylene glycol, α,ω-dihydroxy-PEG, pentaerythritol, sugar alcohols such as xylitol and mannitol, catechol, or the like, or combinations thereof), di- and/or poly-carboxylic acids (such as citric, tartaric, fumaric, oxalic, succinic, oxalic acid, malonic, glutamic, adipic, maleic, aconitic, trimellitic, or the like) and/or salts thereof (such as sodium, lithium, potassium, magnesium, calcium, ammonium, or the like), mixed di- and/or poly-functional compounds (such as ethanolamine, glycolic acid, citric acid, lactic acid, malic acid, salicylic acid, gallic acid, hydroxyaniline, or the like), or the like, or combinations thereof.

Also advanageously, the crosslinked gels according to the invention can be visually translucent, and preferably visually transparent or visually clear. Aside from visual determination of translucency, transparency, and/or clarity, the crosslinked gels according to the invention can have a low turbidity. For example, the crosslinked gels according to the invention can exhibit a turbidity of not more than about 1, in other embodiments not more than about 0.5, while in other embodiments not more than about 0.3, for example of about 0, or alternately a turbidity that is not significantly measurably distinguishable, in terms of experimental error, from 0.

In some embodiments of the invention, especially when visually transparent or visually clear, the crosslinked gels according to the invention can have an equilibrium water content (EWC) of at least about 1.8, in other embodiments of at least about 2, for example of at least about 3, alternately from about 2 to about 4. See, e.g., FIG. 26.

The array of pore sizes in the crosslinked gels according to the invention can advantageously include at least a broad distribution of pore sizes, for example a multimodal or bimodal distribution with at least “macropores” and “micropores.” In some embodiments of the invention the “macropores” can have a distribution of sizes/diameters in which at least about 90% are from about 300 nm to about 2 microns, while in other embodiments at least about 75% from about 500 nm to about 1.5 microns. In some embodiments of the invention the “macropores” can have an average size/diameter from about 400 nm to about 1.2 microns, while other embodiments from about 500 nm to about 1 micron, for example from about 600 nm to about 900 nm. In one embodiment the “macropores” can have an average size/diameter on the order of about 800 nm.

In some embodiments of the invention the “micropores” can have a distribution of sizes/diameters in which at least about 98% are from about 4 nm to about 150 nm, in others at least about 90% from about 5 nm to about 100 nm, or alternately at least about 99% up to about 100 nm. In one embodiment the “micropores” can have an average size/diameter from about 20 nm to about 75 nm, in others from about 30 nm to about 65 nm, for example from about 40 nm to about 55 nm. In one embodiment the “micropores” can have an average size/diameter on the order of about 50 nm.

In some embodiments of the invention the ratio of the average sizes/diameters of “macropores” to “micropores” can advantageously be between about 2 and about 25, in others from about 4 to about 20, for example from about 5 to about 15, or alternately from about 5 to about 10.

In embodiments of the invention where the crosslinked gels are full IPNs containing first and second components, the total combined amount of first monomer/oligomer/polymer and first crosslinker can be from about 5% to about 80% by weight, or from about 10% to about 60%, for example from about 10% to about 40%, or alternately from about 20% to about 30%, depending upon the desired pore size, application, transparency/clarity, and other potential factors. In one embodiment where the crosslinked gels are full IPNs containing first and second components, the total combined amount of second monomer/oligomer/polymer and second crosslinker can be from about 20% to about 60% by weight, or from about 25% to about 50%, for example from about 25% to about 40%, or alternately from about 25% to about 35%, depending upon the desired pore size, application, transparency/clarity, and other potential factors. In embodiments where the crosslinked gels are full IPNs containing first and second components, the amount of aqueous solvent can advantageously be from about 1% to about 65%, or from about 5% to about 60%, for example from about 15% to about 50%, alternately from about 25% to about 45%, depending upon a variety of factors.

In embodiments where the crosslinked gels are full IPNs containing first and second components, the ratio of the amounts of the first monomer/oligomer/polymer to the second monomer/oligomer/polymer can range from about 0.2 to about 4, or from about 0.5 to about 2, for example from about 0.7 to about 1.5.

Advantageously, the crosslinked gels according to the invention can be used as separation media, as electrophoresis gels, as size exclusion media, as chromatography media, as ion exchange media, in prosthetic devices, as drug release matrices, as tissue scaffolds, as (portions of) artificial organs, as specialized adhesives, as eyewear such as contact lenses, or the like, or any combination thereof.

Also advantageously, the crosslinked gels according to the invention can attain transparency/clarity over a range of component concentrations that is wider than would be measured/observed in uncrosslinked aqueous systems, in less heavily crosslinked aqueous systems, and/or in systems containing higher water contents. Without being bound to theory, it is believed that the gels according to the invention, and the methods utilized to synthesize/manufacture them, can “lock in” a homogeneous (single-phase) structure/solution created with lower molecular weight components, and thus maintain a wider range of transparency/clarity as crosslinked gels.

### EXAMPLES

### Example 1

### Preparation of Monomer Solutions

Two terms are introduced to classify the monomer solutions:

% M refers to the total concentration of monomer as a weight percentage; % X refers to the number of double bonds on the crosslinkers as a portion of the total number of double bonds on the monomers.

$$\% M = \frac{total mass of monomers ( \$ ) \times 100}{mass of reaction mixture ( g )}$$

$$\% X = \frac{number of double bonds on crosslinkers ( mol ) \times 100}{total number of double bonds on monomers ( mol )}$$

### Preparation of Acrylamide Hydrogels

### Example 2

### Preparation of 10% M 2% X AAm/BIS Hydrogels for Swelling Tests Using Water as Solvent

Monomer solutions (10 g) were prepared by dissolving AAm (978.3 mg) and BIS (21.7 mg) In water (9 g) in disposable glass vials. The monomer solution was then degassed by argon purging for 5 min prior to the addition of the initiator system (0.2 mol % initiator per double bond) composed of freshly made up 10% (w/v) APS and 10% (v/v) TEMED. The polymerization was then allowed to proceed at room temperature overnight under an argon environment.

### Example 3

### Preparation of 10% M 2% X AAm/B1S Hydrogels for Swelling Tests Using Aqueous Ethylene Glycol as Solvent

Aqueous solutions of ethylene glycol (25, 50 and 75%) were prepared by varying amounts of ethylene glycol and water. AAm (978.3 mg) and BIS (21.7 mg) were added to the above solutions (9 g) in disposable glass vials. The monomer solution was then degassed by argon purging for 5 min prior to the addition of the initiator system (0.2 mol % initiator per double bond) composed of freshly made up 10% (w/v) APS and 10% (v/v) TEMED. The polymerization was then allowed to proceed at room temperature overnight under an argon environment.

### Example 4

### Preparation of 10% M 2% X AAm/BIS Hydrogels for Swelling Tests Using Aqueous Propylene Glycol as Solvent

Aqueous solutions of propylene glycol (25, 50 and 75%) were prepared by varying amounts of ethylene glycol and water. AAm (978.3 mg) and BIS (21.7 mg) were added to the above solutions (9 g) in disposable glass vials. The monomer solution was then degassed by argon purging for 5 min prior to the addition of the initiator system (0.2 mol % initiator per double bond) composed of freshly made up 10% (w/v) APS and 10% (v/v) TEMED. The polymerization was then allowed to proceed at room temperature overnight under an argon environment.

### Example 5

### Preparation of 10% M 2% X AAm/BIS Hydrogels for Swelling Tests Using Aqueous Tri(Ethylene Glycol) as Solvent

Aqueous solutions of triethylene glycol (22, 44, 67 and 72%) were prepared by varying amounts of triethylene glycol and water. AAm (978.3 mg) and BIS (21.7 mg) were added to the above solutions (9 g) in disposable glass vials. The monomer solution was then degassed by argon purging for 5 min prior to the addition of the initiator system (0.2 mol % initiator per double bond) composed of freshly made up 10% (w/v) APS and 10% (v/v) TEMED. The polymerization was then allowed to proceed at room temperature overnight under an argon environment.

### Example 6

### Preparation of 10% M 2% X AAm/BIS Hydrogels for Swelling Tests Using Aqueous Polyethylene Glycol) 400 as Solvent

Aqueous solutions of poly(ethylene glycol) 400 (6, 11, 16 and 22%) were prepared by varying amounts of poly(ethylene glycol) 400 and water. AAm (978.3 mg) and BIS (21.7 mg) were added to the above solutions (9 g) In disposable glass vials. The monomer solution was then degassed by argon purging for 5 min prior to the addition of the initiator system (0.2. mol % initiator per double bond) composed of freshly made up 10% (w/v) APS and 10% (v/v) TEMED. The polymerization was then allowed to proceed at room temperature overnight under an argon environment.

### Example 7

### Preparation of 10% M 2% X AAm/BIS Hydrogels for Turbidity Measurements Using Aqueous Tri(Ethylene Glycol) as Solvent

Aqueous solutions of tri(ethylene glycol) (11, 22, 33, 44, 55, 61, 64, 66, 69 and 72%) were prepared by varying amounts of tri(ethylene glycol) and water. AAm (978.3 mg) and BIS (21.7 mg) was added to the above solutions (9 g) in disposable glass vials. The monomer solution was then degassed by argon purging for 5 min prior to the addition of the initiator system (0.2 mol % initiator per double bond) composed of freshly made up 10% (w/v) APS and 10% (v/v) TEMED. Two 375 μl samples were pipetted into disposable cuvettes (10×10×45 mm³) and the polymerization was then allowed to proceed at room temperature overnight under an argon environment.

### Example 8

### Preparation of 10% M 2% X AAm/BIS Hydrogels for Turbidity Measurements Using Aqueous Polyethylene Glycol) 400 as Solvent

Aqueous solutions of poly(ethylene glycol) 400 (6, 11, 16, 19, 22, 27 and 33%) were prepared by varying amounts of poly(ethylene glycol) 400 and water. AAm (978.3 mg) and BIS (21.7 mg) were added to the above solutions (9 g) in disposable glass vials. The monomer solution was then degassed by argon purging for 5 min prior to the addition of the initiator system (0.2 mol % initiator per double bond) composed of freshly made up 10% (w/v) APS and 10% (v/v) TEMED. Two 375 μl samples were pipetted into disposable cuvettes (10×10×45 mm³) and the polymerization was then allowed to proceed at room temperature overnight under an argon environment.

### Example 9

### Preparation of 10% M 2% X AAm/BIS Hydrogels for Turbidity Measurements Using Aqueous Poly(Ethylene Glycol) 400 as Solvent at 40° C.

Aqueous solutions of poly(ethylene glycol) 400 (6, 11, 16, 19, 22, 27, and 33%) were prepared by varying amounts of poly(ethylene glycol) 400 and water. AAm (978.3 mg) and BIS (21.7 mg) were added to the above solutions (9 g) in disposable glass vials. The monomer solution was then placed in a 40° C. water bath for 15 mins and degassed by argon purging for 5 min prior to the addition of the initiator system (0.2 mol % initiator per double bond) composed of freshly made up 10% (w/v) APS and 10% (v/v) TEMED. Two 375 pl samples were pipetted into disposable cuvettes (10×10×45 mm³) and the polymerization was then allowed to proceed at 40° C. for 2 hr under an argon environment.

### Example 10

### Preparation of 10% M 2% X AAm/BIS Hydrogels for Turbidity Measurements Using Aqueous Poly(Ethylene Glycol) 20,000 as Solvent

Aqueous solutions of poly(ethylene glycol) 20,000 (0.02, 0.04, 0.06, 0.08, 0.1, 0.12 and 0.14%) were prepared by varying amounts of poly(ethylene glycol) 20,000 and water. AAm (978.3 mg) and BIS (21.7 mg) were added to the above solutions (9 g) in disposable glass vials. The monomer solution was then degassed by argon purging for 5 min prior to the addition of the initiator system (0.2 mol % initiator per double bond) composed of freshly made up 10% (w/v) APS and 10% (v/v) TEMED. Two 375 μl samples were pipetted into disposable cuvettes (10×10×45 mm³) and the polymerization was then allowed to proceed at room temperature overnight under an argon environment.

### Example 11

### Preparation of 10% M 2% X AAm/BIS Hydrogel Cassettes for Gel Electrophoresis Using Water as Solvent

10% M 2% X solutions (10 g) were prepared by dissolving AAm (978.3 mg) and BIS (21.7 mg) in water (6.5 g) and 1.5M Tris-HCl buffer (pH 8.8, 2.5 g). The stock buffer solution was prepared by dissolving Tris (27.23 g) in water (80 ml) and adjusted to the 30 pH of 8.8 with 6 N HCl followed by making up the required volume (150 ml) with water.

The monomer solution was degassed by argon purging for 5 min prior to the addition of the initiator system (0.2 mol % initiator per double bond) composed of freshly made up 10% (w/v) APS (64.1 μg) and 10% (v/v) TEMED (42.4 μg). The gel solution (7 ml) was then immediately cast between two glass plates (8×8 cm, 1 mm apart) that were purged with argon and left to polymerize at room temperature for 3 hr under an argon environment prior to use.

### Example 12

### Preparation of 10% M 2% X AAm/BIS Hydrogel Cassettes for Gel 5 Electrophoresis Using 25% Aqueous Ethylene Glycol as Solvent

10% M 2% X solutions (10 g) were prepared by dissolving AAm (978.3 mg) and BIS (21.7 mg) in ethylene glycol (2.7 g) and water (3.8 g). 1.5M Tris-HCl buffer (pH 8.8, 2.5 g). The stock buffer solution was prepared by dissolving Tris (27.23 g) in water (80 ml) and adjusted to the pH of 8.8 with 6 N HCL followed by making up the required volume (150 ml) with water.

The monomer solution was degassed by argon purging for 5 min prior to the addition of the initiator system (0.2 mol % initiator per double bond) composed of freshly made up 10% (w/v) APS (64.1 μg) and 10% (v/v) TEMED (42.4 μg). The gel solution (7 ml) was then immediately cast between two glass plates (8×8 cm, 1 mm apart) that were purged with argon and left to polymerize at room temperature for 3 hr under an argon environment prior to use.

### Example 13

### Preparation of 10% M 2% X AAm/BIS Hydrogel Cassettes for Gel Electrophoresis Using 25% Aqueous Propylene Glycol as Solvent

10% M 2% X solutions (10 g) were prepared by dissolving AAm (978.3 mg) and BIS (21.7 mg) in propylene glycol (2.7 g) and water (3.8 g). 1.5M Tris-HCl buffer (pH 8.8, 2.5 g). The stock buffer solution was prepared by dissolving Tris (27.23 g) in water (80 ml) and adjusted to the pH of 8.8 with 6 N HCL followed by making up the required volume (150 ml) with water.

The monomer solution was degassed by argon purging for 5 min prior to the addition of the initiator system (0.2 mol % initiator per double bond) composed of freshly made up 10% (w/v) APS (64.1 μg) and 10% (v/v) TEMED (42.4 μg). The gel solution (7 ml) was then immediately cast between two glass plates (8×8 cm, 1 mm apart) that were purged with argon and left to polymerize at room temperature for 3 hr under an argon environment prior to use.

### Example 14

### Preparation of 10% M 2% X AAm/BIS Hydrogel Cassettes for Gel Electrophoresis Using 11% Aqueous Tri(Ethylene Glycol) as Solvent

10% M 2% X solutions (10 g) were prepared by dissolving AAm (978.3 mg) and BIS (21.7 mg) in tri(ethylene glycol) (1.2 g) and water (5.3 g). 1.5M Tris-HCl buffer (pH 8.8, 2.5 g). The stock buffer solution was prepared by dissolving Tris (27.23 g) in water (80 ml) and adjusted to the pH of 8.8 with 6 N HCL followed by making up the required volume (150 ml) with water.

The monomer solution was degassed by argon purging for 5 min prior to the addition of the initiator system (0.2 mol % initiator per double bond) composed of freshly made up 10% (w/v) APS (64.1 μg) and 10% (v/v) TEMED (42.4 μg). The gel solution (7 ml) was then immediately cast between two glass plates (8×8 cm, 1 mm apart) that were purged with argon and left to polymerize at room temperature for 3 hr under an argon environment prior to use.

### Example 15

### Preparation of 10% M 2% X AAm/BIS Hydrogel Cassettes for Gel Electrophoresis Using 5.5 and 11% Aqueous Polyethylene Glycol) 400 as Solvent

10% M 2% X solutions (10 g) were prepared by dissolving AAm (978.3 mg) and BIS (21.7 mg) in poly(ethylene glycol) 400 (0.6 or 1.2 g) and water (5.3 or 5.9 g). 1.5M Tris-HCl buffer (pH 8.8, 2.5 g). The stock buffer solution was prepared by dissolving Tris (27.23 g) in water (80 ml) and adjusted to the pH of 8.8 with 6 N HCL followed by making up the required volume (150 ml) with water.

The monomer solution was degassed by argon purging for 5 min prior to the addition of the initiator system (0.2 mol % initiator per double bond) composed of freshly made up 10% (w/v) APS (64.1 μg) and 10% (v/v) TEMED (42.4 μg). The gel solution (7 ml) was then immediately cast between two glass plates (8×8 cm, 1 mm apart) that were purged with argon and left to polymerize at room temperature for 3 hr under an argon environment prior to use.

Evaluation of Acrylamide Hydrogels

Swelling Tests

Gels made according to Examples 2-6 were immersed in water (500 g) for 1 week during which the immersing solution (water) was exchanged on a daily basis. The gel was then dried in a 40° C. oven for 1 week. The equilibrium solvent content of the gel was determined by the following equation.

$$Equilibrium solvent content ( ESC ) = \frac{weight ( swollen gel ) - weight ( dried gel )}{weight ( dried gel )}$$

### Example 16

### ESC (Water) of AAm/BIS Hydrogels Synthesized in Water and Aqueous Solutions of Ethylene Glycol

| Polymerization Solvent | ESC |
|---|---|
| water | 12.1 |
| 25% ethylene glycol/75% water | 14.3 |
| 50% ethylene glycol/50% water | 15.4 |
| 75% ethylene glycol/25% water | 20.0 |

### Example 17

### ESC (Water) of AAm/BIS Hydrogels Synthesized in Water and Aqueous Solutions of Propylene Glycol

| Polymerization Solvent | ESC |
|---|---|
| water | 12.1 |
| 25% propylene glycol/75% water | 15.3 |
| 50% propylene glycol/50% water | 21.9 |
| 75% propylene glycol/25% water | 28.6 |

### Example 17

### ESC (Water) of AAm/BIS Hydrogels Synthesized in Water and Aqueous Solutions of Tri(Ethylene Glycol)

| Polymerization Solvent | ESC |
|---|---|
| water | 12.1 |
| 11% tri(ethylene glycol)/89% water | 12.7 |
| 22% tri(ethylene glycol)/78% water | 14.5 |
| 33% tri(ethylene glycol)/66% water | 16.3 |
| 44% tri(ethylene glycol)/56% water | 18.1 |
| 55% tri(ethylene glycol)/45% water | 21.8 |
| 61% tri(ethylene glycol)/39% water | 25.0 |
| 64% tri(ethylene glycol)/36% water | 26.3 |
| 66% tri(ethylene glycol)/134% water | 26.7 |
| 69% tri(ethylene glycol)/31% water | 30.0 |
| 72% tri(ethylene glycol)/28% water | 32.8 |

### Example 17

### ESC (Water) of AAm/BIS Hydrogels Synthesized in Water and Aqueous Solutions of Polyethylene Glycol) 400

| Polymerization Solvent | ESC |
|---|---|
| water | 12.1 |
| 6% poly(ethylene glycol) 400/94% water | 13.2 |
| 11% poly(ethylene glycol) 400/89% water | 14.0 |
| 16% poly(ethylene glycol) 400/84% water | 15.2 |
| 22% poly(ethylene glycol) 400/78% water | 17.3 |

Turbidity Measurements

The turbidity of gels made according to examples 7-9 was measured using UV-visible spectrophotometry. Distilled water was used for the baseline and the absorbance of each gel sample and the corresponding polymerization solvent were recorded at 100 nm intervals between 300 and 800 nm. The turbidity of the gel samples were determined by the following equation.
Turbidity=−logₑ(10^{-(absorbance of M1-absorbance of polymerization solvent)})

### Example 18

### Turbidity of 10% M 2% X AAm/BIS Hydrogels Synthesized in Water and Aqueous Solutions of Poly(Ethylene Glycol) 400 at 500 nm (Room Temperature and 40° C.)*

| | Turbidity | Turbidity |
|---|---|---|
| Polymerization Solvent | (Room Temp) | (40° C.) |
| 6% poly(ethylene glycol) 400/94% water | 0 | 0 |
| 11% poly(ethylene glycol) 400/89% water | 0 | 0 |
| 16% poly(ethylene glycol) 400/84% water | 0.23 | 0 |
| 19% polyethylene glycol) 400/81% water | 0.46 | 0.18 |
| 22% poly(ethylene glycol) 400/78% water | 1.27 | 0.32 |
| 27% poly(ethylene glycol) 4001.73% water | 6.90 | 5.4 |
| 33% poly(ethylene glycol) 400/66% water | 8.06 | 7.5 |

*Visual opacity corresponds to a turbidity value of 0.3 at 500 nm

### Example 19

### Turbidity of 10% M 2% X AAm/BIS Hydrogels Synthesized in Water and Aqueous Solutions of Tri(Ethylene Glycol), Polyethylene Glycol) 400 and Poly(Ethylene Glycol) 20,000 at 500 nm (Room Temperature)

Turbidity testing showed that the onset of opacity occurs at 72%, 19% and 0.15 for aqueous solution of tri(ethylene glycol), polyethylene glycol) 400 and poly(ethylene glycol) 20,000 respectively.

Gel Electrophoresis

Standard SDS-PAGE was performed on the acrylamide hydrogel cassette (example 11-15) using a constant voltage of 150 V and Tris-glycine electrophoresis running buffer. The electrophoresis running buffer (100 ml) was prepared by dissolving Tris (9 g), SDS (3 g), and glycine (43.2 g) in water and diluting 1:5. with water before use. 10 μl of Kaleidoscope pre-stained protein marker or SDS-PAGE molecular weight standards (broad range) was syringed into sample wells and separated. Gels with SDS PAGE molecular weight standards (broad range) were stained for 3 hr using Coomassie Blue solution and de-stained overnight with 10% aqueous acetic acid. The migration ratio of a protein was determined by the following equation:

$$Migration Ratio = \frac{distance traveled by protein}{distance traveled by dyefront}$$

Kaleidoscope Prestained Standards (Bio-Rad 161-0324)

| Protein | Calibrated MW |
|---|---|
| Myosin | 206,000 |
| G3-galactosidase | 128,000 |
| Bovine serum albumin | 81,000 |
| Carbonic anhydrase | 40,300 |
| Soybean trypsin inhibitor | 31,600 |
| Lysozyme | 19,300 |
| Aprotinin | 7,800 |

SDS-PAGE Molecular Weight Standards
(board range, Bio-Rad 161-0317)

| Protein | Calibrated MW |
|---|---|
| Myosin | 200,000 |
| p-galactosidase | 116,250 |
| Phosphorylase b | 97,400 |
| Serum albumin | 66,200 |
| Ovalbumin | 45,000 |
| Carbonic anhydrase | 31,000 |
| Trypsin inhibitor | 21,500 |
| Lysozyme | 14,400 |
| Aprotinin | 6,500 |

### Example 20

### Electrophoresis of 10% M 2% X AAm/BIS Gel Cassette Synthesized in Water and Aqueous Solutions of Ethylene Glycol or Propylene Glycol

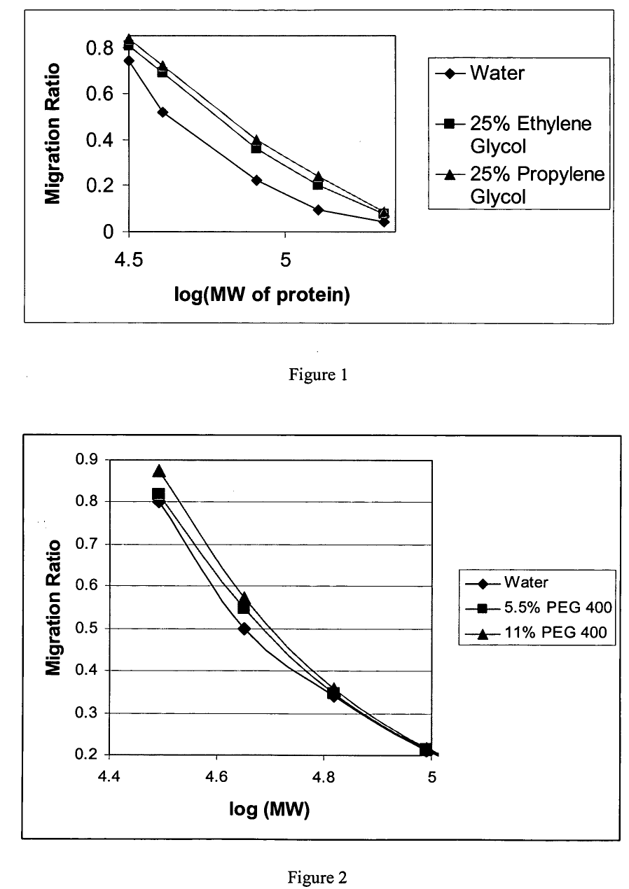

Migration ratios of Kaleidoscope Pre-stained Standards in 10% M 2% X acrylamide gel cassette synthesized in water, aqueous solutions of ethylene glycol (25%) or propylene glycol (25%) are shown in FIG. 1.

### Example 21

### Electrophoresis of 10% M 2% X Acrylamide Gel Cassette Synthesized in Water and Aqueous Solutions of Poly(Ethylene Glycol) 400

Migration ratios of SDS-PAGE Molecular Weight Standards (board range) in 10% M 2% X acrylamide gel cassette synthesized in water, or aqueous solutions of poly(ethylene glycol) are shown in FIG. 2.

### Example 22

### Electrophoresis of 10% M 2% X AAm/B1S Gel Cassette Synthesized in Water and Aqueous Solutions of Tri(Ethylene Glycol) or Polyethylene Glycol) 400

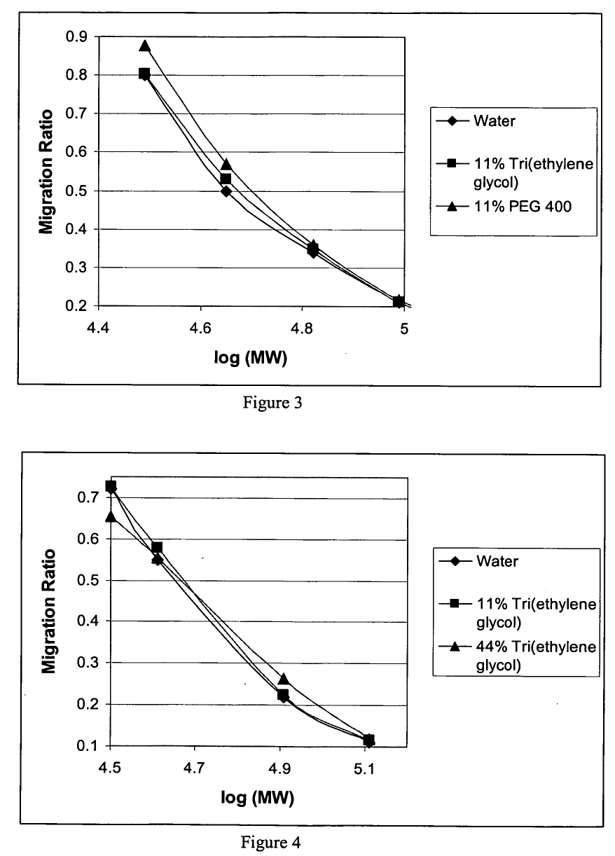

Migration ratios of SDS-PAGE Molecular Weight Standards (board range) in 10% M 2% X acrylamide gel cassette synthesized in water or aqueous solutions of tri(ethylene glycol) and poly(ethylene glycol) are shown in FIG. 3.

### Example 23

### Electrophoresis of 10% M 2% X AAm/BIS Gel Cassette Synthesized in Water and Aqueous Solutions of Tri(Ethylene Glycol)

Migration ratios of Kaleidoscope Prestained Standards in 10% M 2% X acrylamide gel cassette synthesized in water and aqueous solutions of tri(ethylene glycol) are shown in FIG. 4.

Preparation of Methacrylamide Hydrogels

### Example 24

### Preparation of 10% M 2% X Methacrylamide/N,N′-methylenebismethacrylamide Hydrogels Using Aqueous Glycerol as Solvent

Aqueous solution of glycerol (75%) were prepared by mixing appropriate amount of water and glycerol. Methacrylamide (978.6 mg) and N,N′-methylenebismethacrylamide (21.4 mg) were added to the above solutions (9 g) in disposable glass vials. The monomer solution was then degassed by argon purging for 5 min prior to the addition of the initiator system (0.2 mol % initiator per double bond) composed of freshly made up 10% (w/v) APS and 10% (v/v) TEMED. The polymerization was then allowed to proceed at room temperature overnight under an argon environment to produce a hydrogel that was visually clear.

Opacity and reduction in mechanical integrity was observed when the above methacrylamide hydrogel was equilibrated in water.

Preparation of 2-Hydroxyethyl Acrylate (HEA) Hydrogels

### Example 25

### Preparation of HEA/EGDA Hydrogels Using Water as Solvent

10% M HEA hydrogels at 3, 4, 5, 6, and 10% X were prepared by mixing the appropriate amount of HEA, EGDA. The monomer solution was then degassed by argon purging for 5 min prior to the addition of the initiator system (0.2 mol % initiator per double bond) composed of freshly made up 10% (w/v) APS and 10% (v/v) TEMED. The polymerization was then allowed to proceed at room temperature overnight under an argon environment.

All of the resultant polymers were not visually clear, the opacity was observed to 30 increase with increasing % X.

### Example 26

### Preparation of 10% M 6.5% X HEA/EGDA Hydrogels Using Aqueous Ethylene Glycol as Solvent

Aqueous solutions of ethylene glycol (20, 40, 60 and 80%) were prepared by varying amounts of ethylene glycol and water. HEA (951.5 mg) and EGDA (48.5 mg) were added to the above solutions (9 g) in disposable glass vials. The monomer solution was then degassed by argon purging for 5 min prior to the addition of the initiator system (0.2 mol % initiator per double bond) composed of freshly made up 10% (w/v) APS and 10% (v/v) TEMED. The polymerization was then allowed to proceed at room temperature overnight under an argon environment.

The polymers synthesized in 0 and 20% ethylene glycol solutions were opaque. The polymer synthesized in 40% ethylene glycol solution was slightly opalescence. The polymer synthesized in 60 and 80% ethylene glycol solutions were visually clear and remained visually dear after equilibration in water.

### Example 27

### Preparation of 10% M 6.5% X HEA/EGDA Hydrogels Using Aqueous Solutions of Poly(Ethylene Glycol) 200, Tetrahydrofuran, or Methanol as Solvent

60% aqueous solutions of PEG 200, tetrahydrofuran, or methanol were prepared. HEA (951.5 mg) and EGDA (48.5 mg) were added to the above solutions (9 g) in disposable glass vials. The monomer solution was then degassed by argon purging for 5 min prior to the addition of the initiator system (0.2 mol % initiator per double bond) composed of freshly made up 10% (w/v) APS and 10% (v/v) TEMED. The polymerization was then allowed to proceed at room temperature overnight under an argon environment.

The polymers synthesized in 60% PEG 200, 60% tetrahydrofuran, and 60% methanol were visually clear. All gels were visually clear and remained visually clear after equilibration in water.

Preparation of 2-Hydroxyethyl Methacrylate (HEMA) Hydrogels

### Example 28

### Preparation of 5% X HEMA/EGDMA Hydrogels Using Water as Solvent

10%, 20%, 30% and 40% M HEMA hydrogels were prepared by mixing the appropriate amount of HEMA, EGDMA and water (10 g total) in disposable glass vials. The monomer solution was then degassed by argon purging for 5 min prior to the addition of the initiator system (0.2 mol % initiator per double bond) composed of freshly made up 10% (w/v) APS and 10% (v/v) TEMED. The polymerization was then allowed to proceed at room temperature overnight under an argon environment.

All of the resultant polymers were highly opaque and had little mechanical strength.

### Example 29

### Preparation of 15% M 5% X HEMA/EGDMA Hydrogels for Turbidity Measurements Using Aqueous Ethylene Glycol, Tri(Ethylene Glycol), PEG 400 or PEG 6,000 as Solvent

Aqueous solutions of ethylene glycol, tri(ethylene glycol), PEG 400 or PEG 6,000 (40, 45, 50, 60 and 70%) were prepared. HEMA (1.442 g) and EGDMA (57.8 mg) were added to the above solutions (8.5 g) in disposable glass vials. The monomer solution was then degassed by argon purging for 5 min prior to the addition of the initiator system (0.2 mol % initiator per double bond) composed of freshly made up 10% (w/v) APS and 10% (v/v) TEMED. Two 375 μl samples were pipetted into disposable cuvettes (10×10×45 mm′) and the polymerization was then allowed to proceed at room temperature overnight under an argon environment.

### Example 30

### Preparation of 15% M HEMA/EGDMA Hydrogels for Turbidity Measurements Using 50% PEG 200 as Solvent

Aqueous solution of PEG 200 (50%) was prepared by mixing the appropriate amount of PEG 200 and water. 15% M HEMA hydrogels with 0, 2.5, 5, 7.5 and 10% X were prepared by mixing the appropriate amounts of HEMA, EGDMA and 50% PEG solution (10 g total) in disposable glass vials. The monomer solution was then degassed by argon purging for 5 min prior to the addition of the initiator system (0.2 mol % initiator per double bond) composed of freshly made up 10% (w(v) APS and 10% (v/v) TEMED. Two 375 0 samples were pipetted into disposable cuvettes (10×10×45 mm) and the polymerization was then allowed to proceed at room temperature overnight under an argon environment.

### Example 31

### Preparation of 5% X HEMA/EGDMA Hydrogels for Turbidity Measurements Using 50% PEG 200 as Solvent

Aqueous solution of PEG 200 (50%) was prepared by mixing the appropriate amount of PEG 200 and water. 5% X HEMA hydrogels with 7.5, 10, 12.5, 15, 20, 40% T were prepared by mixing the appropriate amounts of HEMA, EGDMA and 50% PEG-solution (10 g total) in disposable glass vials. The monomer solution was then degassed by argon purging for 5 min prior to the addition of the initiator system (0.2 mol % initiator per double bond) composed of freshly made up 10% (w/v) APS and 10% (v/v)-TEMED.

Two 375 μl samples were pipetted into disposable cuvettes (10×10×45 mm³) and the polymerization was then allowed to proceed at room temperature overnight under an argon environment.

### Example 32

### Preparation of 15% M 5% X HEMA/EGDMA Hydrogels for Turbidity Measurements Using Aqueous Propylene Glycol, Tri(Propylene Glycol) or PPG 425 as Solvent

Aqueous solutions of propylene glycol, tri(propylene glycol) or PPG 425 (30, 35, 40, 45 and 50%) were prepared. HEMA (1.442 g) and EGDMA (57.8 mg) were added to the above solutions (8.5 g) in disposable glass vials. The monomer solution was then degassed by argon purging for 5 min prior to the addition of the initiator system (0.2 mol % initiator per double bond) composed of freshly made up 10% (w/v) APS and 10% (v/v) TEMED. Two 375 gi samples were pipetted into disposable cuvettes (10×10×45 mm³) and the polymerization was then allowed to proceed at room temperature overnight under an argon environment.

### Example 33

### Preparation of 15% M 5% X HEMA/EGDMA Hydrogels for Turbidity Measurements Using Aqueous PEG Dimethyl Ether 500 as Solvent

Aqueous solutions of PEG dimethyl ether 500 (30, 35, 40, 45 and 50%) were prepared. HEMA (1.442 g) and EGDMA (57.8 mg) were added to the above solutions (8.5 g) in disposable glass vials. The monomer solution was then degassed by argon purging for 5 min prior to the addition of the initiator system (0.2 mol % initiator per double bond) composed of freshly made up 10% (w/v) APS and 10% (v/v) TEMED. Two 375 pl samples were pipetted into disposable cuvettes (10×10×45 mm³) and the polymerization was then allowed to proceed at room temperature overnight under an argon environment.

### Example 34

### Preparation of 15% M 5% X HEMA/EGDMA Hydrogels for Turbidity Measurements Using Aqueous Ethylene Glycol Monomethyl Ether, Ethylene Glycol Monoethyl Ether or Ethylene Glycol Monobutyl Other as Solvent

Aqueous solutions of ethylene glycol monomethyl ether, ethylene glycol monoethyl ether or ethylene glycol monobutyl ether (30, 35, 40, 45 and 50%) were prepared. HEMA (1.442 g) and EGDMA (57.8 mg) were added to the above solutions (8.5 g) in disposable glass vials. The monomer solution was then degassed by argon purging for 5 min prior to the addition of the initiator system (0.2 mol % initiator per double bond) composed of freshly made up 10% (w/v) APS and 10% (v/v) TEMED. Two 375 μL samples were pipetted into disposable cuvettes (10×10×45 mm³) and the polymerization was then allowed to proceed at room temperature overnight under an argon environment.

### Example 35

### Preparation of 15% M 5% X HEMA/EGDMA Hydrogels for Turbidity Measurements Using Aqueous poly(ethylene glycol-co-propylene glycol) 2,500 (poly(eg-co-pg) 2,000), Polyethylene glycol-co-propylene glycol) 12,000 (poly(eg-co-pg) 12,000), or poly(ethylene glycol-block-propylene glycol-block-ethylene glycol) 1,900 (poly(eg-b-pg-b-eg) 1,900) as Solvent

Aqueous solutions of poly(eg-co-pg) 2,000, poly(eg-co-pg) 12,000 or poly(eg-b-pg-b-eg) 1,900 (30, 35, 40, 45 and 50%) were prepared. HEMA (1.442 g) and EGDMA (57.8 mg) were added to the above solutions (8.5 g) in disposable glass vials. The monomer solution was then degassed by argon purging for 5 min prior to the addition of the initiator system (0.2 mol % initiator per double bond) composed of freshly made up 10% (w/v) APS and 10% (v/v) TEMED. Two 375 μl samples were pipetted into disposable cuvettes (10×10×45 mm³) and the polymerization was then allowed to proceed at room temperature overnight under an argon environment.

### Example 36

### Preparation of 15% M 5% X HEMA/EGDMA Hydrogels for Turbidity Measurements Using Aqueous PEG 400 or PPG 425 as Solvent

Aqueous solutions of PEG 400 or PPG 425 (30, 50, 70 and 90%) were prepared. HEMA (1.442 g) and EGDMA (57.8 mg) were added to the above solutions (8.5 g) in disposable glass vials. The monomer solution was then degassed by argon purging for 5 min prior to the addition of the initiator system (0.2 mol % initiator per double bond) composed of freshly made up 10% (w/v) APS and 10% (v/v) TEMED. Two 375 μl samples were pipetted into disposable cuvettes (10×10×45 mm³) and the polymerization was then allowed to proceed at room, temperature overnight under an argon environment.

### Example 37

### Preparation of 15% M 5% X HEMA/EGDMA Hydrogels for Turbidity Measurements Using Aqueous Solutions of poly(eg-b-pg-b-eg) 1900 and PEG 400 Mixtures as Solvent

40% aqueous solutions of poly(eg-b-pg-b-eg) 1900 and PEG 400 mixtures (0, 12.5, 25, 50, 75, 87.5 and 100% poly(eg-b-pg-b-eg) 1900) were prepared. HEMA (1.442 g) and EGDMA (57.8 mg) were added to the above solutions (8.5 g) in disposable glass vials. The monomer solution was then degassed by argon purging for 5 min prior to the addition of the initiator system (0.2 mol % initiator per double bond) composed of freshly made up 10% (w/v) APS and 10% (v/v) TEMED. Two 375 μl samples were pipetted into disposable cuvettes (10×10×45 mm³) and the polymerization was then allowed to proceed at room temperature overnight under an argon environment.

### Example 38

### Preparation of 15% M 5% X HEMA/EGDMA Hydrogels for Turbidity Measurements Using Aqueous Solutions of Ethylene Glycol Monomethyl Ether and PEG 200 Mixtures as Solvent

35% aqueous solutions of ethylene glycol monomethyl ether and PEG 200 mixtures (0, 14, 28, 57, 86 and 100% ethylene glycol monomethyl ether) were prepared. HEMA (1.442 g) and EGDMA (57.8 mg) were added to the above solutions (8.5 g) in disposable glass vials. The monomer solution was then degassed by argon purging for 5 min prior to the addition of the initiator system (0.2 mol % initiator per double bond) composed of freshly made up 10% (w/v) APS and 10% (v/v) TEMED. Two 375 μl samples were pipetted into disposable cuvettes (10×10×45 mm³) and the polymerization was then allowed to proceed at room temperature overnight under an argon environment.

### Example 39

### Preparation of 5% X HEMA/EGDMA Hydrogels for Swelling Tests Using Aqueous Tri(Ethylene Glycol) as Solvent

Aqueous solution of tri(ethylene glycol) (60%) were prepared. 20, 40, 60 and 80% M HEMA/EGDMA hydrogels were prepared by mixing the appropriate amount of HEMA, EGDMA and the above 60% tri(ethylene glycol) solution In disposable glass vials (10 g total). The monomer solution was then degassed by argon purging for 5 min prior to the addition of the initiator system (0.2 mol % initiator per double bond) composed of freshly made up 10% (w/v) APS and 10% (v/v) TEMED. The polymerization was then allowed to proceed at room temperature overnight under an argon environment.

### Example 40

### Preparation of 10% M 5% X HEMA/EGDMA Hydrogels for Swelling Tests Using Water and Aqueous Solutions of PEG 200 or PEG 4000 as Solvent

Aqueous solutions of PEG 200 or PEG 4000 (50%) were prepared. HEMA (1.442 g) and EGDMA (57.8 mg) were added to the above solutions (8.5 g) in disposable glass vials. The monomer solution was then degassed by argon purging for 5 min prior to the addition of the initiator system (0.2 mol % initiator per double bond) composed of freshly made up 10% (w/v) APS and 10% (v/v) TEMED. The polymerization was then allowed to proceed at room temperature overnight under an argon environment.

### Example 41

### Preparation of 15% M 4% X HEMA/EGDMA Membrane for Electrophoretic Separation Analysis Using Aqueous Solutions of PEG 200 as Solvent

Unwoven poly(ethylene terephthalate) (PET) sheets that served as a mechanical 20 support were treated with aqueous solution of Teric BL8 (0.5% (v/v)), Huntsman Corp. Australia) a non-ionic surfactant used to improve surface wettability.

Aqueous solution of PEG 200 (80%) were prepared. 15% M 4% X HEMA/EGDMA mixtures with the above PEG 200 solution were polymerized into thin membranes with Teric BL8 treated unwoven PET sheet as the supporting substrate.

Evaluation of HEMA Hydrogels Turbidity Testing

All HEMA hydrogels which were visually-clear after the synthesis remained visually clear after the solvent was exchanged with water.

### Example 42

### Turbidity of 15% M 5% X HEMA/EGDMA Hydrogels Synthesized in Aqueous Ethylene Glycol, Tri(Ethylene Glycol), PEG 400 or PEG 6,000 Solutions at 500 nm

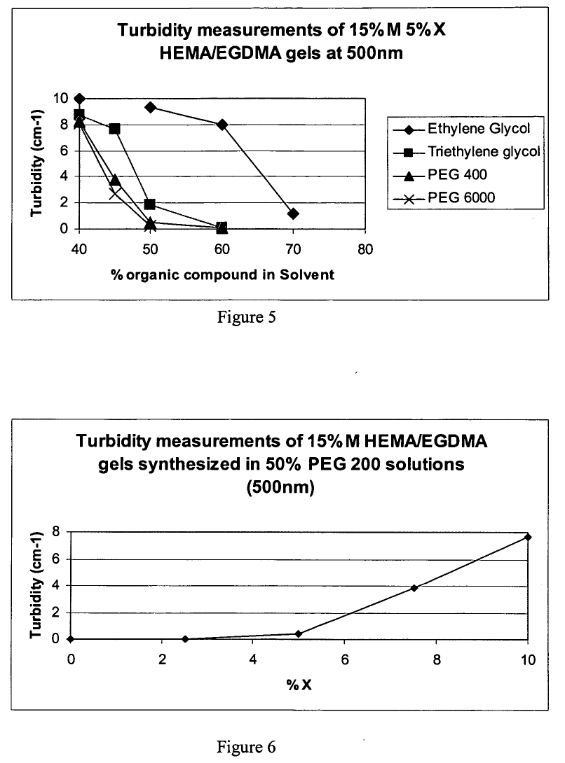

Turbidity results of polymers synthesized according to Example 29 are shown in FIG. 5.

### Example 43

### Turbidity of 15% M HEMA/EGDMA Hydrogels Synthesized in 50% Aqueous PEG 200 Solution at 500 nm

Turbidity results of polymers synthesized according to Example 30 are shown in FIG. 6.

### Example 44

### Turbidity of 5% X HEMA/EGDMA Hydrogels Synthesized in 50% Aqueous PEG 200 Solution at 500 nm

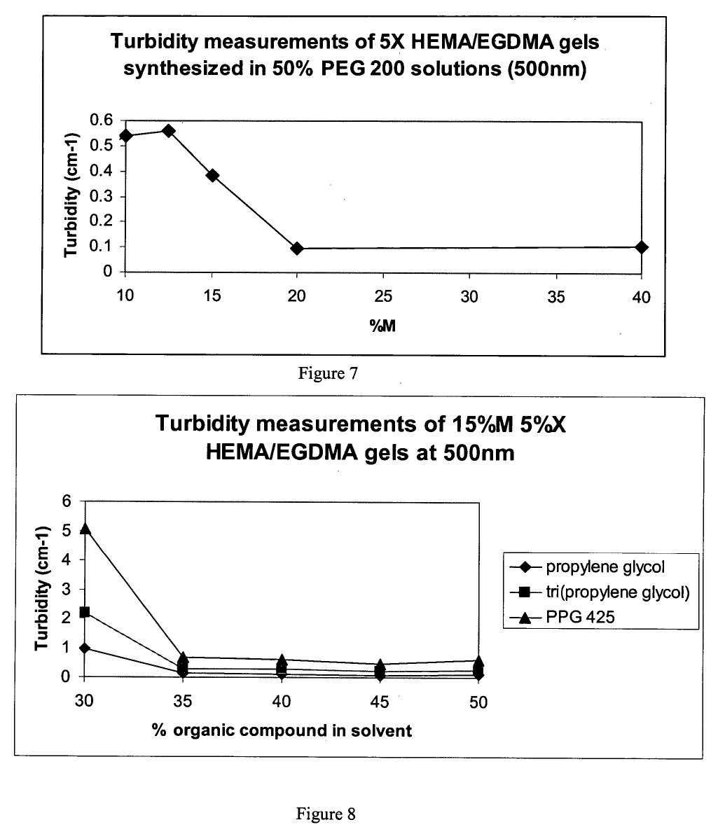

Turbidity results of polymers synthesized according to Example 31 are shown in FIG. 7.

### Example 45

### Turbidity of 15% M 5% X HEMA/EGDMA Hydrogels Synthesized in Aqueous Propylene Glycol, Tri(Propylene Glycol) or PPG 425 as Solvent

Turbidity results of polymers synthesized according to Example 32 are shown in FIG. 8.

### Example 46

### Turbidity of 15% M 5% X HEMA/EGDMA Hydrogels Synthesized in Aqueous PEG Dimethyl Ether 500 Solutions

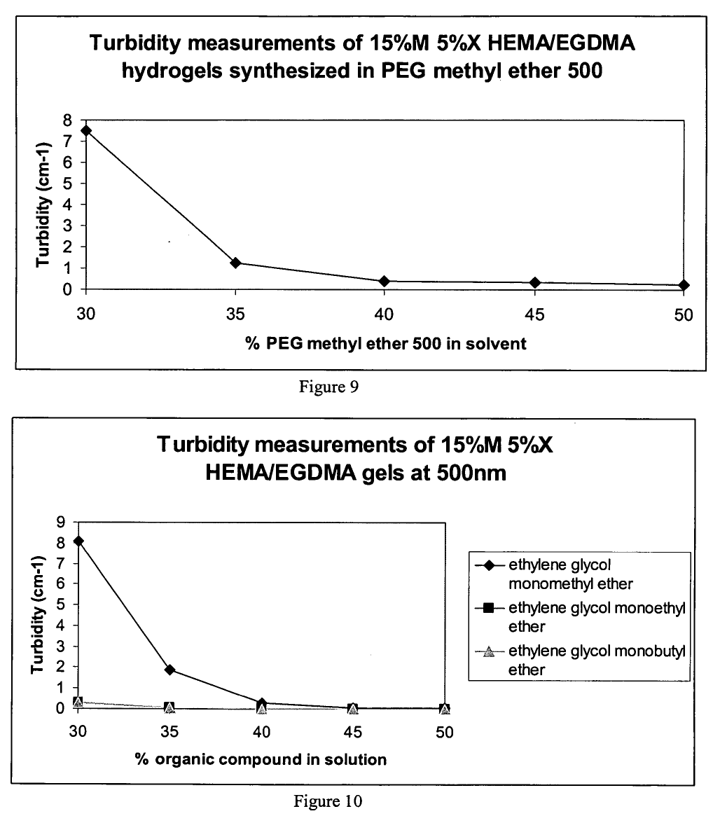

Turbidity results of polymers synthesized according to Example 33 are shown in FIG. 9.

### Example 47

### Turbidity of 15% M 5% X HEMA/EGDMA Hydrogels Synthesized in Aqueous Ethylene Glycol Monomethyl Ether, Ethylene Glycol Monoethyl Ether or Ethylene Glycol Monobutyl Ether as Solvent

Turbidity results of polymers synthesized according to Example 34 are shown in FIG. 10.

### Example 48

### Turbidity of 15% M 5% X HEMA/EGDMA Hydrogels Synthesized in Aqueous poly(ethylene glycol-co-propylene glycol) 2,500 (poly(eg-co-pg) 2,000), poly(ethylene glycol-co-propylene glycol) 12,000 (poly(eg-co-pg) 12,000), or poly(ethylene glycol-block-propylene glycol-block-ethylene glycol) 1,900 (poly(eg-b-pg-b-eg) 1,900) as Solvent

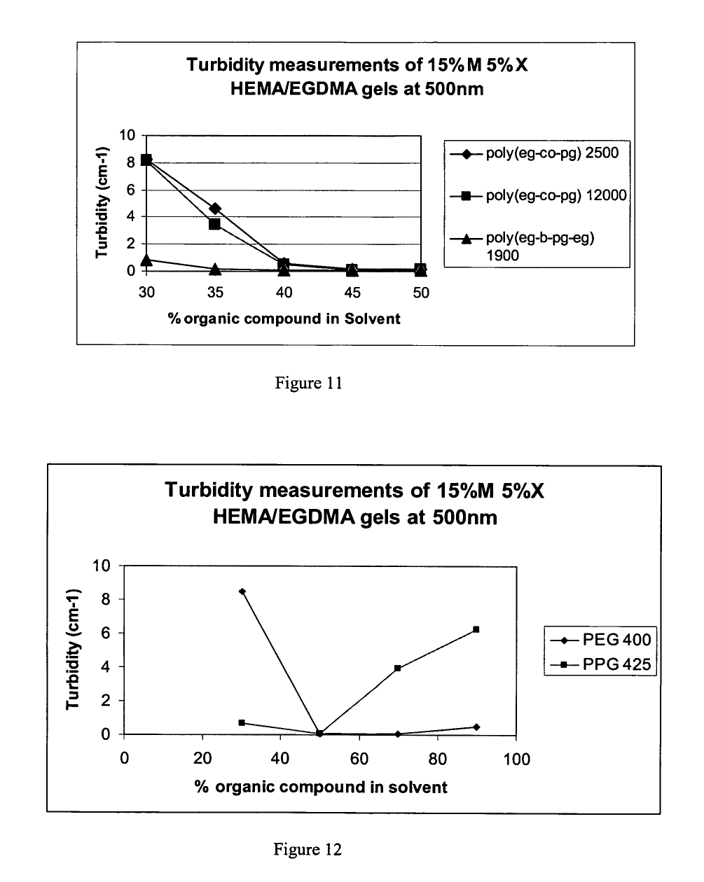

Turbidity results of polymers synthesized according to Example 35 are shown in FIG. 11.

### Example 49

### Turbidity of 15% M 5% X HEMA/EGDMA Hydrogels Synthesized in Aqueous PEG 400 or PPG 425 as Solvent

Turbidity results of polymers synthesized according to Example 36 are shown in FIG. 12.

### Example 50

### Turbidity of 15% M 5% X HEMA/EGDMA Hydrogels Synthesized in Aqueous Solutions of poly(eg-b-pg-b-eg) 1900 and PEG 400 Mixtures as Solvent

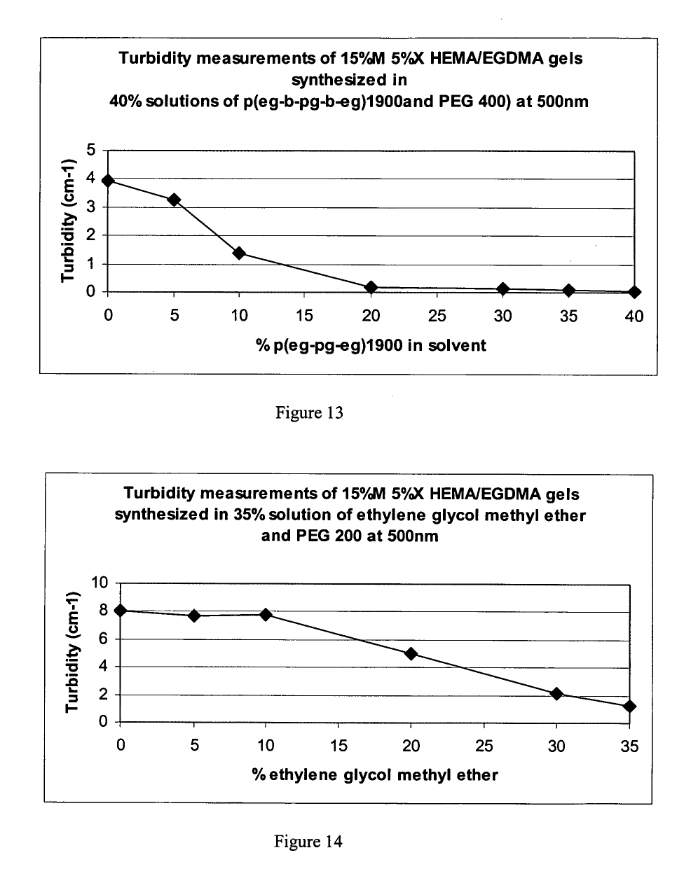

Turbidity results of polymers synthesized according to example 37 are shown in FIG. 13.

### Example 51

### Turbidity of 15% M 5% X HEMA/EGDMA Hydrogels Synthesized in Aqueous Solutions of Ethylene Glycol Monomethyl Ether and PEG 200 Mixtures as Solvent

Turbidity results of polymers synthesized according to Example 38 are shown in FIG. 14.

### Example 52

### Swelling Test (Water) of 5% X HEMA/EGDMA Hydrogels at 20, 40, 60, 80% M Synthesized in 60% Aqueous Tri(Ethylene Glycol) Solution

| Hydrogel | ESC (water) |
|---|---|
| 20% M 5% X | 0.81 |
| 40% M 5% X | 0.72 |
| 60% M 5% X | 0.56 |
| 80% M 5% X | 0.54 |

### Example 53

### Swelling Test (Water) of 15% M 5% X HEMA/EGDMA Hydrogels Synthesized in 50% Aqueous Solutions of PEG 200 or PEG 4000

ESC (water) for 15% M 5% X HEMA/EGDMA hydrogel synthesized in 50% PEG 200 solution was found to be 0.65. ESC (water) for 15% M 5% X HEMA/EGDMA hydrogel synthesized in 50% PEG 4000 solution was found to be 0.83.

### Example 54

### Swelling Test (40% Aqueous Solutions of Ethylene Glycol, PEG 600, PEG 4000 or PEG 6000) of 15% M 5% X HEMA/EGDMA Hydrogels Synthesized in 50% Aqueous Solutions of PEG 200 or PEG 400

Hydrogels prepared in Example 40 were immersed in water (500 g) for 1 week during which the immersing solution (water) was exchanged on a daily basis. The gel was then dried in a 40° C. oven for 1 week. The dried gels were then immersed in 50% aqueous solutions of ethylene glycol, PEG 600, PEG 4000 or PEG 6000) for 1 week during which the immersing solution was exchanged on a daily basis. The ESC of the gels are shown in the following table.

| | | ESC | ESC | ESC |
|---|---|---|---|---|
| | ESC | (40% PEG | (40% PEG | (40% PEG |
| | (40% EG) | 600) | 4000) | 6000) |
| 15% M 5% X hydrogels | 0.98 | 2.99 | 1.31 | 1.14 |
| synthesized in 50% PEG | | | | |
| 200 | | | | |
| 15% M 5% X hydrogels | 1.30 | 3.48 | 3.00 | 2.45 |
| synthesized in 50% PEG | | | | |
| 4000 | | | | |

### Example 55

### Electrophoresis Separation Analysis of 15% M 4% X HEMA/EGDMA Membrane Synthesized in 80% Aqueous PEG 200 Solution

Samples of known molecular weight and size were run through a Gradiflow™ BF 200 unit to investigate the relative pore size formed in HEMA hydrogel networks. The protein standards were placed in a buffer solution and run by current from the stream 1 section of the unit above the membrane. Proteins smaller than the pores of the membrane will pass through the membrane into the stream 2 section of the unit. The larger proteins will be recycled back into the stream 1 section. Ten μl samples from both the two streams of the unit are taken every 10 minutes and detected using SDS-PAGE. The migration pattern should indicate what sized samples passed through the membrane. More details on the construction and operation of this unit can be found in U.S. Pat. No. 5,650,055, U.S. Pat. No. 5,039,386, WO 00/56792, and WO 00/13776, incorporated herein by reference.

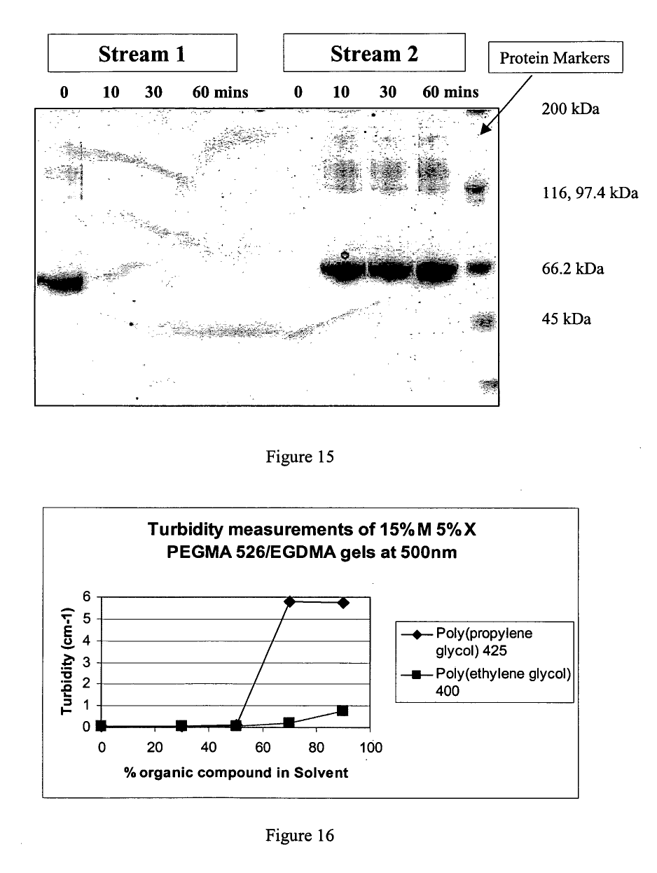

The separation and migration pattern of Bovine serum albumin (MW 67,000) by a 15% M 4% X HEMA/EGDMA membrane synthesized in 80% aqueous PEG 200 solution (Example 41) using 40 mM MES bis-TRIS buffer is shown in FIG. 15.

Preparation of Poly(Ethylene Glycol) Methacrylate (HEMA) Hydrogels

### Example 56

### Preparation of 15% M 5% X PEGMA 526/EGDMA Hydrogels for Turbidity Measurements Using Aqueous PEG 400 or PPG 425 as Solvent

Aqueous solutions of PEG 400 or PPG 425 (0, 30, 50 and 70%) were prepared. PEGMA (1.485 g) and EGDMA (14.7 mg) were added to the above solutions (8.5 g) in disposable glass vials. The monomer solution was then degassed by argon purging for 5 min prior to the addition of the initiator system (0.2 mol % initiator per double bond) composed of freshly made up 10% (w/v) APS and 10% (v/v) TEMED. Two 375 μl samples were pipetted into disposable cuvettes (10×10×45 mm³) and the polymerization was then allowed to proceed at room temperature overnight under an argon environment.

### Example 57

### Turbidity of 15% M 5% X PEGMA 526/EGDMA Hydrogels Synthesized in Aqueous PEG 400 or PPG 425 as Solvent

Turbidity results of polymers synthesized according to Example 56 are shown in FIG. 16.

Preparation of Optically Clear Hydrogels

### Example 58

### ¹³C NMR Relaxation Measurements of Acrylamide Hydrogels

Monomer solutions (2 g) were prepared by dissolving AAm and Bis in the appropriate amount of D₂O (10% TMSPA-Na, 0.2 g), water and PEG-400. The monomer solution was then degassed by argon purging prior to the addition of the initiator system composed of freshly made up 10% (w/v) APS and 10% (v/v) TEMED (0.05 mol % initiator per double bond). This mixture was immediately pipetted into 5 mm NMR tube (0.38 mm wall thickness) and the polymerization was allowed to proceed at room temperature overnight under an argon environment.

¹³C NMR spectra were obtained using a Varian Unity Plus 400 spectrometer operating at 100 MHz. Spin-lattice relaxation times (T₁) were measured by the inversion-recovery method at 25° C. Recycled delays were set to 7s (>3T₁), with delay times (τ) of 10, 50, 100, 200, 300, 400, 500, 600, 700, 800, and 1000, ms. The T₁ parameters were calculated by fitting the data to the following equation:
I(τ)=I(τ=0)(1−2 exp(−τ/T₁)) (4)
where I is the intensity of the transformed peaks.

### Example 59

### Real-Time Viscosity Measurements of Acrylamide Polymerizations

Monomer solutions (200 g) were prepared by dissolving AAm and Bis in the appropriate amount of water and PEG-400. The monomer solution was then degassed by argon purging prior to the addition of the initiator system composed of freshly made up 10% (w/v) APS and 10% (v/v) TEMED (0.05 mol % initiator per double bond). The viscosity of the reaction mixture was measured by a Brookfield® DV-II+ viscometer (0.3 rpm, LV-3 spindle). The experiments were performed in a glove box with controlled oxygen levels (<0.1% O₂).

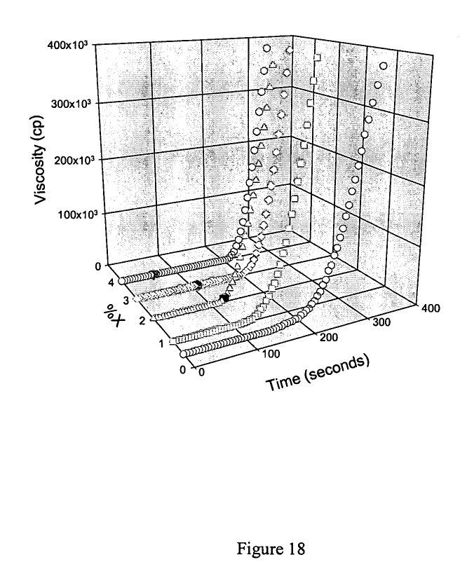

Viscosity measurements of the polymerizations are shown in FIG. 18. Times at which phase separation was observed in the samples are represented by dark colored points (circle).

### Example 60

### Preparation of Acrylamide Hydrogels for Swelling Studies

Monomer solution (10 g) was prepared by dissolving AAm and Bis in an appropriate amount of water and PEG-400 in disposable glass vials. The monomer solution was then degassed by argon purging prior to the addition of the initiator system (0.2 mol % initiator per double bond), composed of freshly made up 10% (w/v) APS and 10% (v/v) TEMED. The polymerization was then allowed to proceed at room temperature overnight under an argon environment.

### Example 61

### Kinetic Swelling Studies of Acrylamide Hydrogels

The gel made according to the above procedure was immersed in water (500 g) for 1 week during which the immersing solution (water) was exchanged on a daily basis. The gel was then dried in a 40° C. oven for 1 week and re-swelled in water. The weight of the swollen gel was continuously monitored for 48 hours. ESC of the gel was determined by the following equation:

$$Equilibrium solvent content ( ESC ) = \frac{weight ( swollen gel ) - weight ( dried gel )}{weight ( dried gel )}$$

### Example 62

### Preparation of 15% M 5% X HEMA/EGDMA Hydrogels Using Aqueous Ethylene Glycol Monomethyl Ether as Solvent

Aqueous solutions of ethylene glycol monomethyl ether (80, 85 and 90%) were prepared. HEMA (1.442 g) and EGDMA (57.8 mg) were added to the above solutions (8.5 g) in disposable glass vials. The monomer solution was then degassed by argon purging prior to the addition of the initiator system (0.2 mol % initiator per double bond) composed of freshly made up 10% (w/v) APS and 10% (v/v) TEMED. The polymerization was then allowed to proceed at room temperature overnight under an argon environment. All resultant gels were visually clear.

### Example 63

### ¹³C T₁ (25° C., 100 MHz) for 20% M 2% X Acrylamide Hydrogels Synthesized in the Presence of Various Amount of PEG-400

| % PEG-400 | T₁ (α-carbon) | T₁ (β-carbon) | T₁ (carbonyl) |
|---|---|---|---|
| 2.5 | 240 | 125 | 1330 |
| 7.5 | 240 | 135 | 1350 |
| 12.5 | 261 | 140 | 1400 |
| 17.5 | 270 | 155 | 1400 |
| 22.5 | 340 | 180 | 1730 |
| 27.5 | 420 | 230 | 2185 |

### Example 64

### ESC (Water) of AAm/BIS Hydrogels from Kinetic Swelling Studies

| | % PEG-400 | | | | |
|---|---|---|---|---|---|
| Time(hr) | 7.5 | 12.5 | 17.5 | 22.5 | 27.5 |
| 0.5 | 3.14 | 3.34 | 3.34 | 2.99 | 2.70 |
| 1 | 3.52 | 3.82 | 3.81 | 3.34 | 2.99 |
| 1.5 | 3.81 | 4.14 | 4.18 | 3.59 | 3.23 |
| 2 | 4.05 | 4.44 | 4.48 | 3.81 | 3.42 |
| 3 | 4.47 | 4.97 | 5.10 | 4.20 | 3.76 |
| 4 | 4.86. | 5.55 | 5.50 | 4.54 | 4.05 |
| 5 | 5.23 | 6.03 | 6.04 | 4.93 | 4.42 |
| 24 | 12.04 | 13.16 | 13.02 | 9.3 | 6.84 |
| 48 | 15.22 | 16.40 | 16.53 | 13.21 | 8.58 |

### Example 65

### Preparation of 20% M 2% X AAm/BIS Hydrogels Using Aqueous PEG-400 as Solvent

Monomer solutions (10 g) were prepared by dissolving AAm and Bis in the appropriate amount of water and PEG 400 in disposable glass vials. The monomer solution was then degassed by argon purging prior to addition of the initiator system (0.05 mol % initiator per double bond) composed of freshly made up 10% (v/v) TEMED and 10% (w/v) APS. The polymerization was then allowed to proceed at room temperature overnight under an argon environment.

### Example 66

### Optical Properties of 20% M 2% X AAm/Bis Hydrogels Synthesized Using Aqueous PEG-400 as Solvent

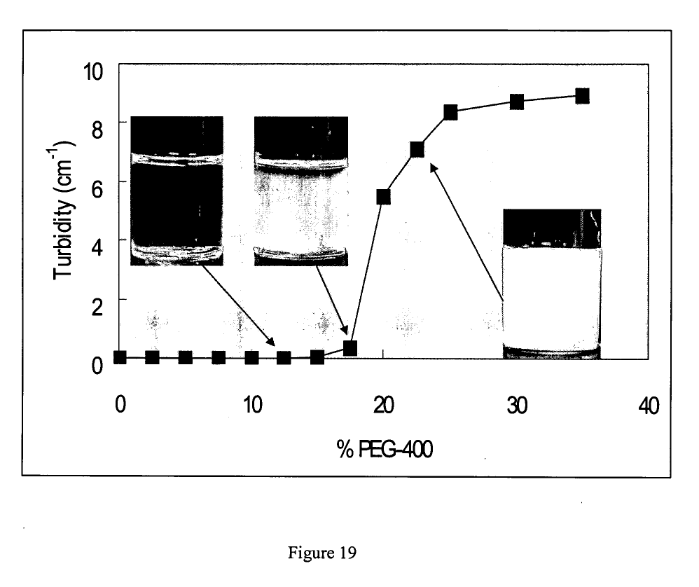

Turbidity results and images of polymers synthesized according to Example 65 are shown in FIG. 19.

### Example 67

### Preparation of Optically Clear HEMA/EGDMA Hydrogels Using Aqueous Propylene Glycol as Solvent

HEMA hydrogels (10%, 20%, 30%, 40%, 50%, 60% M) were prepared by mixing the appropriate amount of HEMA, EGDMA (1% X, 2% X, 4% X, 6% X, 8% X), propylene glycol and water (10 g total) in disposable glass vials. The monomer solution was then degassed by argon purging for 5 min prior to the addition of the initiator system (0.1 mol initiator per double bond) composed of freshly made up 10% (w/v) APS and 10% (v/v) TEMED. The polymerization was then allowed to proceed at room temperature overnight under an argon environment.

The propylene glycol content of each reaction mixture was varied in 2.5% (increments from 0%) until an optically clear hydrogel is obtained.

### Example 68

### Critical Propylene Glycol Concentrations for the Formation of Visually Clear HEMA Hydrogels at Various % M and % X

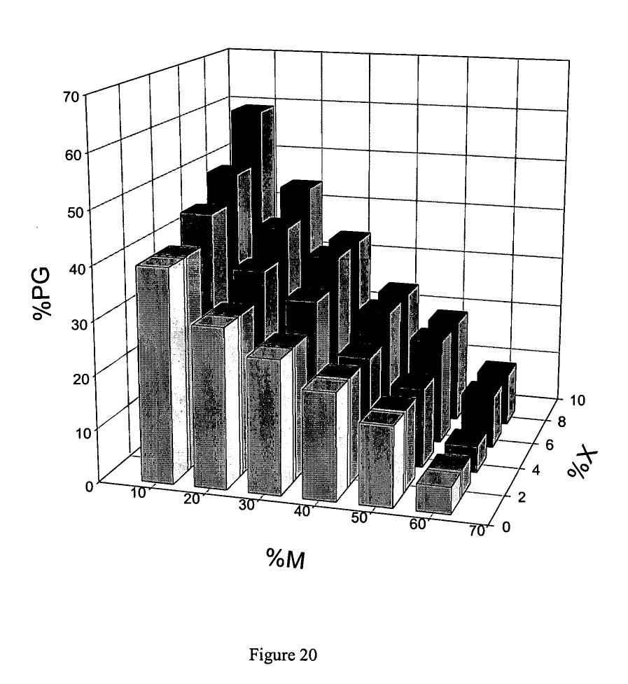

FIG. 20 shows the critical propylene glycol concentrations for the formation of visually hydrogels at various % M and % X.

### Example 69

### Real-Time Viscosity Measurements of 20% M 2% X HEMA Polymerizations Using Aqueous Propylene Glycol as Solvent

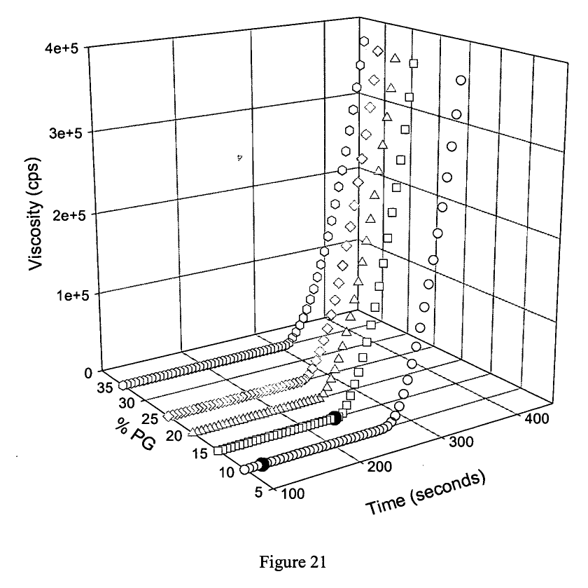

Monomer solutions (200. g) were prepared by mixing HEMA and EGDMA in the appropriate amount of water and PG. The monomer solution was then degassed by argon purging prior to addition of the initiator system composed of freshly made up 10% (w/v) APS and 10% (v/v) TEMED (0.1 mol % initiator per double bond). The viscosity of the reaction mixture was measured by a Brookfield® DV II+ viscometer (0.3 rpm, LV-3 spindle). The experiments were performed in a glove box with controlled oxygen levels (c 0.1% 02). Viscosity measurements of the polymerizations are shown in FIG. 21. Times at which phase separation was observed in the samples are represented by dark colored points (circle).

Scanning Electron Microscopy (SEM)

SEM analysis was performed on the hydrogels synthesized in Examples 3 and 4. After equilibration in water, a piece of hydrogel (5×5 mm) was mounted vertically onto a SEM stub and cryogenically fractured in liquid nitrogen. The water from the fractured surface of the gel was sublimed at −60° C. for 60 min. The gel was then cooled to −190° C. and images of the fractured polymer were taken at 10,000× magnification using a XL30 field emission scanning electron microscope (FESEM).

### Example 70

### SEM Analysis of 10% M 2% X AAm/BIS Hydrogels Synthesized Using Water, 50% Ethylene Glycol, or 50% Propylene Glycol as Solvent

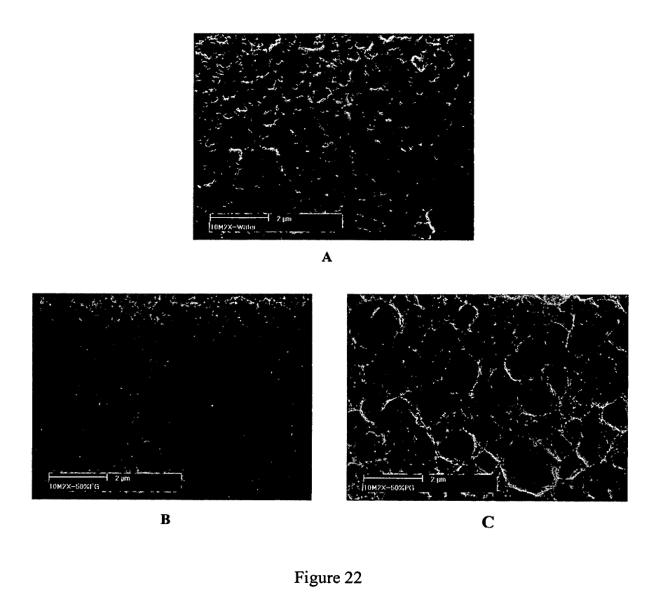

SEM images of the polymers synthesized according to Example 3 and 4 are shown in FIG. 22.

Summary

Examples 2 to 23 show that the following:
Acrylamide hydrogels can undergo polymerization-induced phase separation when it is synthesized in solvents containing poly(ethylene glycol) with 3 repeating units or more.
Turbidity testing showed that the onset of opacity (i.e. phase separation) occurs at lower concentrations of poly(ethylene glycol) with increasing molecular weight of poly(ethylene glycol).
Acrylamide hydrogels synthesized in the presence of water-soluble entities have in general, larger pores than those synthesized in water. Such gels however cannot be synthesized in solvents containing high concentrations of polyethylene glycol) with high molecular weight.
It is well known that when methacrylamide is polymerized in water, an opaque polymer mass is obtained. Example 24 showed that visually clear hydrogels can be obtained from methacrylamide by using hydro-organic solution as the polymerization solvent. Such hydrogels, however, became opaque and lost their mechanical integrity when the organic solvent was subsequently exchanged with water. This demonstrated that although by using a hydro-organic solution as the polymerization solvent, a visually clear hydrogel can be obtained from monomers that produce water-immiscible polymers, many of the resultant hydrogels cannot be used in aqueous media.

Among other things, examples 25-27 show that:
HEA hydrogels that are synthesized using water as solvent are opaque and have poor mechanical integrity.
Visually clear HEA hydrogels can be synthesized by careful selection of water-miscible entities. Such gels remained visually clear after the water-miscible entities were exchanged with water. This contrasts with the teaching from prior art observations made in methacrylamide hydrogels.

Examples 28-37 and 42-51 show that:
HEMA hydrogels that are synthesized In water are opaque and have poor mechanical integrity.
Visually clear HEMA hydrogels can be synthesized by careful selection of water-miscible entities. Such gels remained visually clear after the water-miscible entities were exchanged with water.
HEMA hydrogels have very different behavior to acrylamide hydrogels. Polymerization-induced phase separation occurs at low concentrations of water-miscible entities (e.g. poly(ethylene glycol)), and the gels become more visually clear and the mechanical properties of such gels increases when the concentrations of water-miscible entities increases. This contrasts with prior art acrylamide hydrogels, which state that high concentrations of water-miscible entities would lead to phase separations.
Unexpectedly, turbidity testing shows that in contrast to acrylamide hydrogels, poly(ethylene glycol) with higher molecular weight improves the visual and mechanical properties of the resultant gel (FIG. 5). This contrasts with prior art acrylamide systems, which state that water-miscible entities with high molecular weight would lead to phase separation.

FIG. 7 (Example 31 and 44) shows that visually clear HEMA hydrogels can be obtained from reaction mixtures with low initial monomer concentrations. This contrasts with prior art HEMA gels.

FIGS. 8 and 12 (Example 32, 36 and 45, 49) demonstrate the usage of poly(propylene glycol) as water-miscible entities. The usage of poly(propylene glycol) has not been reported in the literature on hydrogel synthesis.

FIGS. 9 and 10 (Example 33-34 and 46-47) demonstrate the usage of poly(ethylene glycol) derivatives (i.e. alkyl ether) as water-miscible entities. The usage of such derivatives has not been reported in the literature on acrylamide hydrogel synthesis.

FIG. 11 (Example 35 and 48) demonstrate the usage of random and block copolymers of polyethylene glycol) and polypropylene glycol) as water-miscible entities. The usage of such water-miscible entities has not been reported previously.

FIGS. 13 and 14 (Example 38-37 and 49-51) demonstrate the usage of two different types of water-miscible entities together in the same solvent system. The usage of such mixtures of water-miscible entities have not been reported previously.

Example 52 shows that by careful selection of the water-miscible entities, HEMA hydrogels with high water. swelling properties can be formed from monomer mixtures with low monomer concentrations (i.e. <50% M). It also shows the increase in water swelling properties with decreasing total monomer concentrations. This contrasts with the prior which states the opposite.

Examples 52 and 53 show that water swelling properties of HEMA hydrogels are dependent upon the initial monomer concentration, the types of water miscible entities and the concentration of water-miscible entities. Example 53 further demonstrates that the water swelling properties of the hydrogels increases when the molecular weight of the water-miscible entities (i.e. poly(ethylene glycol) is increased.

Example 54 shows the swelling properties of two different hydrogels. Hydrogel A was synthesized in the presence of a water miscible entity with low molecular weight; hydrogel B was synthesized in the presence of a water miscible entity with high molecular weight.

Among other things, swelling of Hydrogel A and B in mixtures composed of water and organic solvents with different molecular weight shows that:
Hydrogel B swells more in all solvents.
Hydrogel A has low swelling properties in solvents with organic solvents with high molecular weight.
Hydrogel B has significantly higher swellings in solvents with high molecular weight than Hydrogel A.

The above observations show that as the molecular weight of the water-miscible entities increases, the pore size of the gels become dependent upon the size of the water-miscible entities. Such gels have macroporous pores and hence are able to swell more in solvents with high molecular weight solutes, because of the increased diffusion of organic solvent with high molecular weights into the gel.

Examples 56 and 57 demonstrate the usages of poly(ethylene glycol) and poly(propylene glycol) as water-miscible entities in other hydrogels prepared from α,ω-(meth)acryloyloxy monomers. Poly(ethylene glycol) methacrylate was used in these examples. The present invention extends to derivatives of HEMA and HEA, that is, monomers with the same (meth)acrylate ester structure with HEMA and HEA, but different side chains.

Example 58 and 63 show that PIPS occur in 20% M 2% X acrylamide hydrogels synthesized in the presence of 22.5 and 27.5% PEG-400, but can be avoided by the careful selection of the polymerization solvent. It is therefore possible to prepare visually clear hydrogels even when the polymerization solvent is immiscible with the corresponding linear polymer analogues.

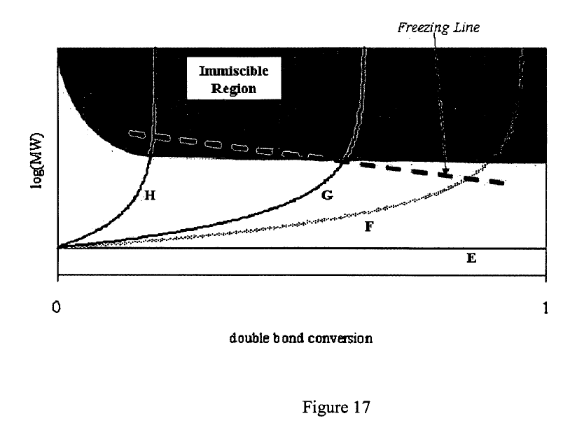

FIG. 17 is a schematic diagram of the formation process of 20% M acrylamide hydrogel, it demonstrates the relationship between the ‘freezing concentration’ of the reaction mixture, the phase boundary, and the concentration and properties of the water-miscible entity which alter the region of immiscibility on the diagram.

Example 59 and FIG. 18 demonstrate the relationship between the ‘freezing concentration’ of the reaction mixture and the phase boundary, it can be seen that visually clear gels can be obtained. In systems where the ‘freezing concentration’ of the reaction mixtures is reached before the onset of PIPS.

Examples 60, 61, and 64 show that hydrogels prepared by the approach of this invention have superior swelling properties to that prepared by systems that reaches the phase boundary before the gel point (22.5 and 27.5% PEG-400).

Example 62 shows that by using a mixture of water and water-miscible entities as the polymerization solvent, visually dear HEMA hydrogels can be prepared even when the polymerization solvent is immiscible with the corresponding linear polymer analogues which are water immiscible.

Examples 65 and 66 show that hydrogels with very different optical properties can be obtained by controlling the ‘freezing point’ of the reaction mixture.

Examples 67 and 68 show that visually clear HEMA hydrogels, at different total monomer concentration and crosslinker concentration, can be synthesized by careful selection of water miscible entities. Such gels remained visually clear after the water-miscible entities were exchanged with water. The critical propylene glycol concentration (and hence critical water content of the reaction mixture) required to obtain a clear gel in these systems are shown in FIG. 20. It can be seen from FIG. 20 that in contrast to the reported values of around 50%, the maximum water content of the reaction mixtures to produce a clear hydrogel is dependent upon both % M and % X. For example, the maximum water content is 30% at 60% M 8% X, and 50% at 10% M 1% X.

Example 69 and FIG. 21 demonstrate the relationship between the ‘freezing concentration’ of the reaction mixture and the phase boundary; it can be seen that visually clear gels can be obtained. In systems where the ‘freezing concentration’ of the reaction mixtures is reached before the onset of PIPS.

Example 70 shows that when compared with AAm hydrogels obtained by existing methods (water as polymerization solvent), hydrogels prepared by the approach of this invention have significantly different pore size/distribution.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

The foregoing detailed description has been given for clearness of understanding only and no unnecessary limitations should be understood therefrom as modifications will be obvious to those skilled in the art.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features herein before set forth and as follows in the scope of the appended claims.

The disclosures of each and every patent, patent application, and publication cited herein including but limited to the additional references listed immediately below are hereby incorporated herein by reference in their entirety.

What is claimed is:

1. A water-swellable, crosslinked gel, exhibiting an array of pore sizes of micropores and macropores, and comprising:
(a) a first gel component comprising
a first monomer, oligomer, polymer, or combination thereof, having at least one polymerizable double bond, and
a first crosslinker having at least two polymerizable double bonds;
(b) a second gel component comprising
a second monomer, oligomer, polymer, or combination thereof, having at least one pendant functional group per repeat unit, and
a second crosslinker having at least two functional groups, each capable of reacting with the at least one pendant functional group of the second monomer, oligomer, polymer, or combination thereof; and
(c) an aqueous solvent,
wherein the first gel component and the second gel component form a full interpenetrating polymer network when polymerized, crosslinked, or both polymerized and crosslinked.

2. The crosslinked gel of claim 1, wherein the macropores have an average diameter from about 400 nm to about 1.2 microns.

3. The crosslinked gel of claim 2, wherein the macropores have an average diameter from about 600 nm to about 900 nm.

4. The crosslinked gel of claim 1, wherein at least about 90% of the macropores have a diameter from about 300 nm to about 2 microns.

5. The crosslinked gel of claim 1, wherein at least about 75% of the macropores have a diameter from about 500 nm to about 1.5 microns.

6. The crosslinked gel of claim 1, wherein the micropores have an average diameter from about 20 nm to about 75 nm.

7. The crosslinked gel of claim 1, wherein at least about 98% of the micropores have a diameter from about 4 nm to about 150 nm.

8. The crosslinked gel of claim 1, wherein at least about 99% of the micropores have a diameter not more than about 100 nm.

9. The crosslinked gel of claim 1, wherein at least about 90% of the micropores have a diameter from about 5 nm to about 100 nm.

10. The crosslinked gel of claim 1, wherein the ratio of the average diameters of the macropores to the micropores is between about 2 and about 25.

11. The crosslinked gel of claim 10, wherein the ratio of the average diameters of the macropores to the micropores is from about 5 to about 15.

12. The crosslinked gel of claim 1, wherein the gel has a turbidity of not more than about 0.5.

13. The crosslinked gel of claim 1, wherein the gel is optically clear.

14. The crosslinked gel of claim 1, wherein:
the first gel component is present in an amount from about 5% to about 80% by weight of the gel; and
the second gel component is present in an amount from about 20% to about 60% by weight of the gel.

15. The crosslinked gel of claim 14, wherein the ratio of the amounts of the first gel component to the second gel component is from about 0.2 to about 4.

16. The crosslinked gel of claim 1, wherein the aqueous solvent is present in an amount from about 5% to about 60%.

17. The crosslinked gel of claim 16, wherein the aqueous solvent is present in an amount from about 25% to about 45%.

18. The crosslinked gel of claim 1, wherein the aqueous solvent is water and wherein the gel exhibits an equilibrium water content of at least about 2.

19. The crosslinked gel of claim 18, wherein the gel exhibits an equilibrium water content of at least about 3.

20. The crosslinked gel of claim 1, wherein the first gel component comprises a hydroxy-functional vinyl acrylate alkyl ester and an alkylene diacrylate, and wherein the second gel component comprises a glycidyl end-capped polyether and a diamine.

21. The crosslinked gel of claim 20, wherein the first gel component comprises hydroxyethylmethacrylate and ethylene glycol dimethacrylate, and wherein the second gel component comprises α,ω-diglycidyl-poly(ethylene oxide) and ethylenediamine.

22. A separation membrane comprising the crosslinked gel of claim 21.

23. A size exclusion medium comprising the crosslinked gel of claim 21.

24. An electrophoresis system comprising: a cathode, an anode, and the crosslinked gel of claim 21.

25. A water-swellable, crosslinked gel, exhibiting an array of pore sizes of micropores and macropores, and comprising:
(a) from about 5% to about 80% of a first gel component comprising hydroxyethylmethacrylate and ethylene glycol dimethacrylate;
(b) from about 20% to about 60% a second gel component comprising α,ω-diglycidyl-poly(ethylene oxide) and ethylenediamine; and
(c) from about 5% to about 60% of an aqueous solvent,
wherein the first gel component and the second gel component form a full interpenetrating polymer network when polymerized, crosslinked, or both polymerized and crosslinked,
wherein the macropores have an average diameter from about 600 nm to about 900 nm and wherein at least about 75% of the macropores have a diameter from about 500 nm to about 1.5 microns,
wherein the micropores have an average diameter from about 20 nm to about 75 nm and wherein at least about 99% of the micropores have a diameter not more than about 100 nm and wherein at least about 90% of the micropores have a diameter from about 5 nm to about 100 nm,
wherein the ratio of the average diameters of the macropores to the micropores is from about 5 to about 15,
wherein the gel has a turbidity of not more than about 0.5, and
wherein the gel exhibits an equilibrium water content of at least about 2.
